(19) United States
(12) Patent Application Publication
(10) Pub. No.: US 2018/0157753 A1
(43) Pub. Date: Jun. 7, 2018

(54) Interactive Data-Driven Graphical User Interfaces for Search Engine Optimization

(71) Applicant: Rise Interactive Media & Analytics, LLC, Chicago, IL (US)

(72) Inventors: Justin Dougherty, Chicago, IL (US); Lawrence Fisher, Chicago, IL (US); Justin Garvin, Chicago, IL (US); Brent Laufenberg, Chicago, IL (US); Jonathon Morris, Chicago, IL (US); Michael Thone, Chicago, IL (US)

(21) Appl. No.: 15/830,589

(22) Filed: Dec. 4, 2017

Related U.S. Application Data
(60) Provisional application No. 62/430,134, filed on Dec. 5, 2016.

(51) Int. Cl. G06F 17/30

(52) U.S. Cl. CPC G06F 17/30864; G06Q 30/0201; G06F 17/3089

(57) ABSTRACT

An embodiment may involve receiving, from a search engine device at which a web site is registered, updates to search engine performance information of the web site. The embodiment may further involve receiving, from one or more traffic tracking service devices, updates to traffic information for the web pages. The embodiment may further involve receiving, via selectable controls on a graphical user interface of a client device, a selection of two or more of a plurality of metrics related to the search engine performance information and the traffic information. The embodiment may further involve transmitting, to the client device, graph data representing values of the selected two metrics over a pre-defined period of time. Reception of the graph data may cause the client device to plot, on the graphical user interface, a graph indicating the values of the selected two metrics over the pre-defined period of time.

### CROSS-REFERENCE TO RELATED APPLICATION

This application claims priority to U.S. provisional patent application No. 62/430,134, filed Dec. 5, 2016, which is hereby incorporated by reference in its entirety.

### BACKGROUND

Search engine optimization (SEO) refers to procedures and operations that can be applied to a web site (or a similar online information source) to make the web site more highly ranked in search engines and/or more associated with particular search keywords and keyphrases that are entered into search engines. Doing so may result in an increase of visitors to the web site, which in turn may lead to an increase in conversions (e.g., sales) and revenue.

Accordingly, an operator of the web site may undertake various activities, such as adding the keywords/keyphrases and variations thereof to the web site, including non-trivial content on the web site that is relevant to the contextual meaning of the keywords, and/or making the web site load and render faster across multiple types of devices, as just some examples. Nonetheless, it may be difficult or impossible for the operator to evaluate the relative performance of particular web pages or particular sets of web pages with respect to various keywords.

### SUMMARY

The embodiments herein involve, but are not limited to, graphic user interfaces that provide online access to dynamically updated SEO information for a particular web site or web sites.

The information that makes up the web site(s) may be stored at Internet addresses as web pages. These addresses, which may appear in the form of uniform resource locators (URLs), are mapped to a site structure that includes a category and/or sub-category for some or all web pages of the web site. The SEO information may be displayed per web page, category, or sub-category, and may include metrics such as search impressions (which may be referred to herein simply as “impressions”), visits, clicks, revenue, downloads, keyword/keyphrase search engine rank, video views, and various types of conversions, for example. The SEO information may also include estimates of traffic attributable to particular keywords. For a web site with dozens, hundreds, or thousands of individual pages, the aggregation of these pages into categories and sub-categories may provide critical insight into the interest in particular products and/services provided by the web site, and well as how the web pages in these categories and sub-categories rank in search results.

This information may be gathered from a number of sources, including search engine devices at which a target web site is registered, and traffic tracking services. These devices and services, however, may have nuances that prevent simple aggregation thereof. For instance, search engine devices may measure the number of times that URLs to particular web pages appeared in search results, some traffic tracking services may measure the number of visits to the particular web pages, while other traffic tracking services may provide information regarding search engine ranking of keywords/keyphrases related to the particular web pages.

Further, some of these sources may provide data on a weekly basis. Thus, this data is always 0-7 days out of date. Other source may provide data with a 1-5 day lag. Thus, this data may be out of date as well. On the other hand, some data is available in near-real-time, and thus is rarely out of date.

In sum, each of these sources provides a limited view into the performance of the web site. By combining data from multiple sources, a more comprehensive representation can be made. But, aggregating the data from these sources into a comprehensive, interactive, and meaningful display is a difficult task that has not been done until now. Thus, the embodiments herein solve technical problems associated with the displaying of SEO-related metrics on a graphical user interface.

Particularly, a first example embodiment may involve receiving, from a search engine device at which a web site is registered, updates to search engine performance information of the web site. The search engine performance information may include search impressions for web pages of the target web site. The first example embodiment may further involve receiving, from one or more traffic tracking service devices, updates to traffic information for the web pages. The traffic information may include (i) visits to the web pages, and (ii) rankings of the web pages by search keywords. The first example embodiment may further involve receiving, via selectable controls on a graphical user interface of a client device, a selection of two or more of a plurality of metrics related to the search engine performance information and the traffic information. The first example embodiment may further involve transmitting, to the client device, graph data representing values of the selected two metrics over a pre-defined period of time. Reception of the graph data may cause the client device to plot, on the graphical user interface, a graph indicating the values of the selected two metrics over the pre-defined period of time. The values as shown in the graph for each of the selected two metrics may be normalized to one another.

In a second example embodiment, an article of manufacture may include a non-transitory computer-readable medium, having stored thereon program instructions that, upon execution by a computing device, cause the computing device to perform operations in accordance with the first example embodiment.

In a third example embodiment, a computing device may include at least one processor, as well as data storage and program instructions. The program instructions may be stored in the data storage, and upon execution by the at least one processor, cause the computing device to perform operations in accordance with the first example embodiment.

In a fourth example embodiment, a system may include various means for carrying out each of the operations of the first example embodiment.

These as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 is a high-level depiction of a client-server computing system, according to an example embodiment.

FIG. 2 illustrates a schematic drawing of a computing device, according to an example embodiment.

FIG. 3 illustrates a schematic drawing of a networked server cluster, according to an example embodiment.

FIG. 4 depicts a web site operator or agency offering graphical user interfaces that provide information on SEO for one or more web sites, according to an example embodiment.

FIG. 5 depicts an architecture for SEO performance tracking, according to an example embodiment.

FIG. 6 depicts relationships between keywords, search engine results, and web pages, according to an example embodiment.

FIG. 7 depicts search engine results, according to an example embodiment.

FIG. 8A depicts an example web site layout, according to an example embodiment.

FIG. 8B depicts another aspect of the example web site layout of FIG. 8A, according to an example embodiment.

FIG. 8C depicts another aspect of the example web site layout of FIG. 8A, according to an example embodiment.

FIG. 8D depicts a hierarchical view of the example web site layout of FIGS. 8A, 8B, and 8C, according to an example embodiment.

FIG. 8E depicts a table mapping URLs of the example web site layout of FIGS. 8A, 8B, and 8C to web pages, categories, and sub-categories, according to an example embodiment.

FIG. 8F depicts further entries in the table of FIG. 8E, according to an example embodiment.

FIG. 9A depicts an SEO insights graphical user interface with a graph and a table, according to an example embodiment.

FIG. 9B depicts an SEO insights graphical user interface with a graph and a table, according to an example embodiment.

FIG. 9C depicts an SEO insights graphical user interface with a graph and a table, according to an example embodiment.

FIG. 9D depicts an SEO insights graphical user interface with a graph and a table, according to an example embodiment.

FIG. 9E depicts an SEO insights graphical user interface with a graph and a table, according to an example embodiment.

FIG. 9F depicts an SEO insights graphical user interface with a graph and a table, according to an example embodiment.

FIG. 9G depicts an SEO insights graphical user interface with a graph and a table, according to an example embodiment.

FIG. 10 depicts a flow chart, according to an example embodiment.

### DETAILED DESCRIPTION

Example methods, devices, media, and systems are described herein. Other embodiments can be utilized, and other changes can be made, without departing from the scope of the subject matter presented herein. Thus, these example embodiments are not meant to be limiting. It will be readily understood that the aspects of the present disclosure, as generally described herein, and illustrated in the figures, can be arranged, substituted, combined, separated, and designed in a wide variety of different configurations, all of which are contemplated herein.

As used herein, the words “example” and “exemplary” mean “serving as an example, instance, or illustration.” Any embodiment or feature described herein as being an “example” or “exemplary” is not necessarily to be construed as preferred or advantageous over other embodiments or features.

The term “optimization” as used herein should not be interpreted to require that the “optimal” or “best” solution to any problem is found. Instead, “optimization” refers to a process through which better results might be obtained. Moreover, the terms “search engine optimization” and “SEO” do not imply that the result of any of the techniques described herein will be an optimal outcome. These terms are merely terms of art. Thus, while the techniques described herein may be able to improve the search engine ranking of a web site, there is no guarantee that this improvement will be optimal in any sense.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### 1. OVERVIEW

With billions of web pages spread across millions of web sites on the Internet, it can be time consuming for users to find the information that they seek. Search engines, such as those operated by GOOGLE® and MICROSOFT®, are essential tools for finding web sites that are relevant to particular keywords or keyphrases. A search engine allows a user to enter such keywords and/or keyphrases, and the search engine provides an ordered list of web sites (i.e., search results) that either contain these keywords and/or keyphrases, or are deemed to have content that is relevant to the keywords and/or keyphrases.

The terms “keywords” and “keyphrases” may refer to single words and groups of words, respectively. For sake of convenience, these terms may be used interchangeably herein. Further, the terms “keywords” and “search keywords” may be used synonymously.

Some of the search results provided by search engines may be paid advertisements from particular web sites, the operators of which having bid on one or more of the entered keywords and paid the search engine entity accordingly. Other search results are organic, in that their search rankings are not based on payments, and are instead due to the search engine determining that the web site is highly relevant to the keywords, contains quality information related thereto, and/or operates well across a variety of client devices (e.g., personal computers, tablets, and smartphones). In some cases, a web site's search rankings may also be based on other web sites referring to the web site as an authority on topics related to the keywords.

As an example, suppose that the web site www.example.com contains information related to automobiles. Perhaps this web site is an auto enthusiast site or is that of an automobile dealership. Such a web site's search engine rankings can be increased by use of the words “auto,” “automobile,” and “car” in a meaningful way throughout the web site, having quality information related to these keywords, and the web pages of the web site loading and rendering in an expeditious fashion.

When a web site is highly ranked for a particular keyword entered, it is more likely that the web site will be visited by a user conducting a web search including that keyword or variations thereof. In particular, since some search engines list ten search results per page, it is advantageous for the web site to be in the top ten results for one or more keywords. In such a case, users will see a link to the web site on the first page of results, may conclude that the web site is highly relevant to their query, and may visit one or more web pages of the web site.

Such visits may result in conversions. For purpose of this discussion, conversions may include any type of desirable action that a user of the web site might take. Examples include a purchase of a product or service, downloading a file, filling out a web-based form, watching a video, or merely a visit to a particular web page. In some case, such as purchases of products or services, a conversion may be associated with an amount of revenue. To the extent that conversions can be associated with a particular web page of the web site, there may be a link between a keyword that leads users to the web page and at least some of the conversions.

Additionally, different keywords may be used to steer user to different web page on the web site. These web pages may, in turn, be logically grouped into one or more categories and/or subcategories. As an example, in a simple web site for a company selling products, all web pages may be placed one of three categories such as “About the Company”, “Product Detail,” and “E-Commerce”. In order to determine the effectiveness of keywords attracting search traffic to these parts of the web site, it may be helpful to be able to present web page traffic, conversions, and associated keywords in terms of the web page's respective categories.

The embodiments herein support methods, devices, and systems for providing a more complete view of a SEO for a web site. These embodiments collect and aggregate information from one or more search engine services, as well as traffic tracking services, to enable performance monitoring of web site traffic and conversions with respect to various search engines and keywords. With this information, web site operators and/or their agencies may be able to make faster, more informed decisions about how to focus their web site's organization and design.

Particularly, the embodiments herein describe interactive data-driven graphical user interfaces, in the form of web pages that allow the user to rapidly compare various types of data related to SEO. For instance, a web site operator or agency may be able to compare, at a glance, the number of keywords for which a particular web page of the web site falls within the top ten search results. Similarly, with simple inputs to the graphical user interfaces, these parties may be able to switch to comparing (i) the number of search impressions that refer to the web site to (ii) the number of times a particular online form on the web site was filled out and submitted.

In this way, the parties may be able to rapidly determine the effectiveness of each of various SEO strategies, and whether they should change strategies for any of the web pages. For instance, if the SEO goal is to increase conversions, the operator or its agency may attempt include more content on the web site that is relevant to a broader array of keywords, or improve the performance of the web site across multiple device types.

While the embodiments herein are described as providing web-based interfaces, other types of interfaces may be used instead. For instance, any of the web-based interfaces herein may be replaced by interfaces of standalone applications for personal computers, tablets, smartphones, etc. Further, even though agencies are described throughout this disclosure as providing aggregated SEO information on behalf of a web site operator, these agencies are not necessary. Thus, the embodiments herein may be used by web site operators themselves without assistance from an agency.

Regardless of how they may be implemented, the embodiments herein may make use of one or more computing devices. These computing devices may include, for example, client devices under the control of users, and server devices that directly or indirectly interact with the client devices. Such devices are described in the following section.

### 2. EXAMPLE COMPUTING DEVICES AND CLOUD-BASED COMPUTING ENVIRONMENTS

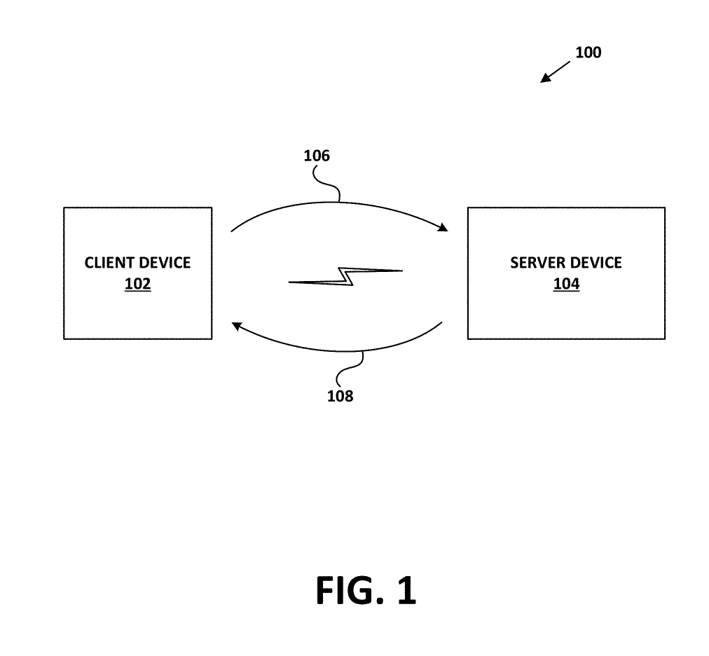

FIG. 1 illustrates an example communication system 100 for carrying out one or more of the embodiments described herein. Communication system 100 may include computing devices. Herein, a “computing device” may refer to either a client device, a server device (e.g., a stand-alone server computer or networked cluster of server equipment), or some other type of computational platform.

Client device 102 may be any type of device including a personal computer, laptop computer, a wearable computing device, a wireless computing device, a head-mountable computing device, a mobile telephone, or tablet computing device, etc., that is configured to transmit data 106 to and/or receive data 108 from a server device 104 in accordance with the embodiments described herein. For example, in FIG. 1, client device 102 may communicate with server device 104 via one or more wireline or wireless interfaces. In some cases, client device 102 and server device 104 may communicate with one another via a local-area network. Alternatively, client device 102 and server device 104 may each reside within a different network, and may communicate via a wide-area network, such as the Internet.

Client device 102 may include a user interface, a communication interface, a main processor, and data storage (e.g., memory). The data storage may contain instructions executable by the main processor for carrying out one or more operations relating to the data sent to, or received from, server device 104. The user interface of client device 102 may include buttons, a touchscreen, a microphone, and/or any other elements for receiving inputs, as well as a speaker, one or more displays, and/or any other elements for communicating outputs.

Server device 104 may be any entity or computing device arranged to carry out the server operations described herein. Further, server device 104 may be configured to send data 108 to and/or receive data 106 from the client device 102.

Data 106 and data 108 may take various forms. For example, data 106 and 108 may represent packets transmitted by client device 102 or server device 104, respectively, as part of one or more communication sessions. Such a communication session may include packets transmitted on a signaling plane (e.g., session setup, management, and teardown messages), and/or packets transmitted on a media plane (e.g., text, graphics, audio, and/or video data).

Regardless of the exact architecture, the operations of client device 102, server device 104, as well as any other operation associated with the architecture of FIG. 1, can be carried out by one or more computing devices. These computing devices may be organized in a standalone fashion, in cloud-based (networked) computing environments, or in other arrangements.

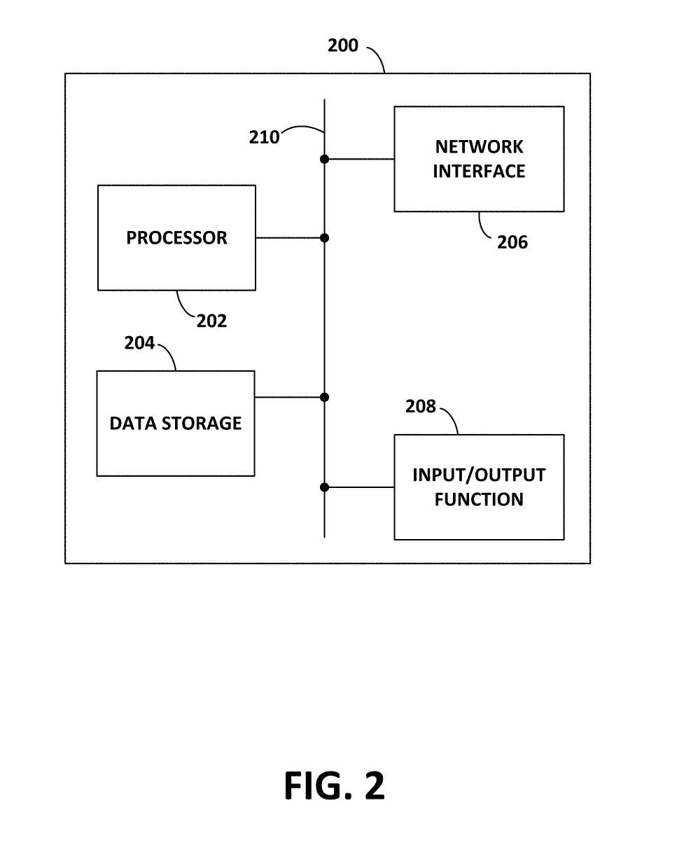

FIG. 2 is a simplified block diagram exemplifying a computing device 200, illustrating some of the functional components that could be included in a computing device arranged to operate in accordance with the embodiments herein. Example computing device 200 could be a client device, a server device, or some other type of computational platform. For purpose of simplicity, this specification may equate computing device 200 to a server from time to time. Nonetheless, the description of computing device 200 could apply to any component used for the purposes described herein.

In this example, computing device 200 includes a processor 202, a data storage 204, a network interface 206, and an input/output function 208, all of which may be coupled by a system bus 210 or a similar mechanism. Processor 202 can include one or more CPUs, such as one or more general purpose processors and/or one or more dedicated processors (e.g., application specific integrated circuits (ASICs), digital signal processors (DSPs), network processors, etc.).

Data storage 204, in turn, may comprise volatile and/or non-volatile data storage and can be integrated in whole or in part with processor 202. Data storage 204 can hold program instructions, executable by processor 202, and data that may be manipulated by these instructions to carry out the various methods, processes, or operations described herein. Alternatively, these methods, processes, or operations can be defined by hardware, firmware, and/or any combination of hardware, firmware and software. By way of example, the data in data storage 204 may contain program instructions, perhaps stored on a non-transitory, computer-readable medium, executable by processor 202 to carry out any of the methods, processes, or operations disclosed in this specification or the accompanying drawings.

Network interface 206 may take the form of a wireline connection, such as an Ethernet, Token Ring, or T-carrier connection. Network interface 206 may also take the form of a wireless connection, such as IEEE 802.11 (Wifi), BLUETOOTH®, or a wide-area wireless connection. However, other forms of physical layer connections and other types of standard or proprietary communication protocols may be used over network interface 206. Furthermore, network interface 206 may comprise multiple physical interfaces.

Input/output function 208 may facilitate user interaction with example computing device 200. Input/output function 208 may comprise multiple types of input devices, such as a keyboard, a mouse, a touch screen, and so on. Similarly, input/output function 208 may comprise multiple types of output devices, such as a screen, monitor, printer, or one or more light emitting diodes (LEDs). Additionally or alternatively, example computing device 200 may support remote access from another device, via network interface 206 or via another interface (not shown), such as a universal serial bus (USB) or high-definition multimedia interface (HDMI) port.

In some embodiments, one or more computing devices may be deployed in a networked architecture. The exact physical location, connectivity, and configuration of the computing devices may be unknown and/or unimportant to client devices. Accordingly, the computing devices may be referred to as “cloud-based” devices that may be housed at various remote locations.

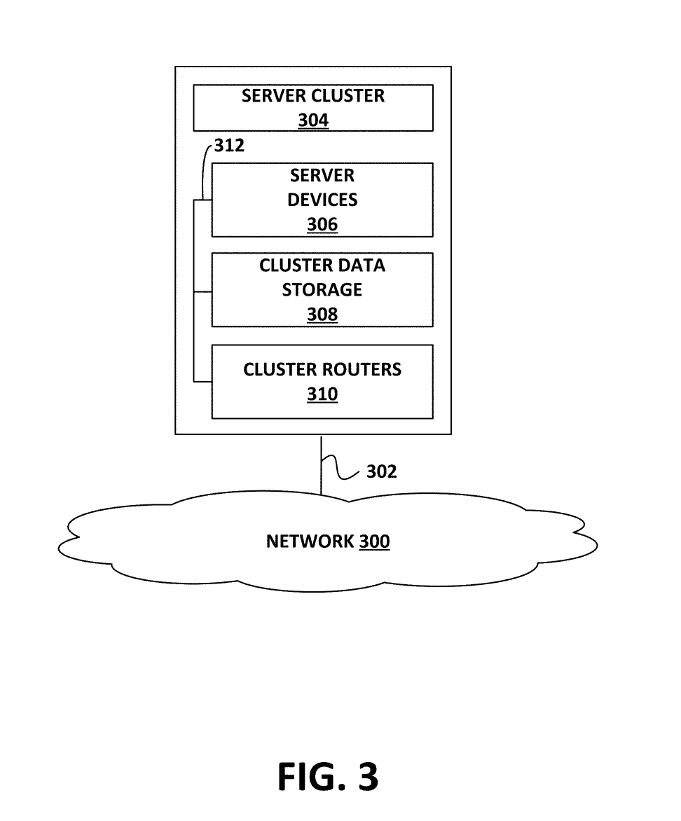

FIG. 3 depicts a cloud-based server cluster 304 in accordance with an example embodiment. In FIG. 3, functions of a server device, such as server device 104 (as exemplified by computing device 200) may be distributed between server devices 306, cluster data storage 308, and cluster routers 310, all of which may be connected by local cluster network 312. The number of server devices, cluster data storages, and cluster routers in server cluster 304 may depend on the computing task(s) and/or applications assigned to server cluster 304.

For example, server devices 306 can be configured to perform various computing tasks of computing device 200. Thus, computing tasks can be distributed among one or more of server devices 306. To the extent that these computing tasks can be performed in parallel, such a distribution of tasks may reduce the total time to complete these tasks and return a result. For purpose of simplicity, both server cluster 304 and individual server devices 306 may be referred to as “a server device.” This nomenclature should be understood to imply that one or more distinct server devices, data storage devices, and cluster routers may be involved in server device operations.

Cluster data storage 308 may be data storage arrays that include disk array controllers configured to manage read and write access to groups of hard disk drives. The disk array controllers, alone or in conjunction with server devices 306, may also be configured to manage backup or redundant copies of the data stored in cluster data storage 308 to protect against disk drive failures or other types of failures that prevent one or more of server devices 306 from accessing units of cluster data storage 308.

Cluster routers 310 may include networking equipment configured to provide internal and external communications for the server clusters. For example, cluster routers 310 may include one or more packet-switching and/or routing devices configured to provide (i) network communications between server devices 306 and cluster data storage 308 via cluster network 312, and/or (ii) network communications between the server cluster 304 and other devices via communication link 302 to network 300.

Additionally, the configuration of cluster routers 310 can be based at least in part on the data communication requirements of server devices 306 and cluster data storage 308, the latency and throughput of the local cluster networks 312, the latency, throughput, and cost of communication link 302, and/or other factors that may contribute to the cost, speed, fault-tolerance, resiliency, efficiency and/or other design goals of the system architecture.

As a possible example, cluster data storage 308 may include any form of database, such as a structured query language (SQL) database. Various types of data structures may store the information in such a database, including but not limited to tables, arrays, lists, trees, and tuples. Furthermore, any databases in cluster data storage 308 may be monolithic or distributed across multiple physical devices.

Server devices 306 may be configured to transmit data to and receive data from cluster data storage 308. This transmission and retrieval may take the form of SQL queries or other types of database queries, and the output of such queries, respectively. Additional text, images, video, and/or audio may be included as well. Furthermore, server devices 306 may organize the received data into web page representations. Such a representation may take the form of a markup language, such as the hypertext markup language (HTML), the extensible markup language (XML), or some other standardized or proprietary format. Moreover, server devices 306 may have the capability of executing various types of computerized scripting languages, such as but not limited to Perl, Python, PHP Hypertext Preprocessor (PHP), Active Server Pages (ASP), JavaScript, and so on. Computer program code written in these languages may facilitate the providing of web pages to client devices, as well as client device interaction with the web pages.

### 3. EXAMPLE SEO ANALYSIS ARCHITECTURES

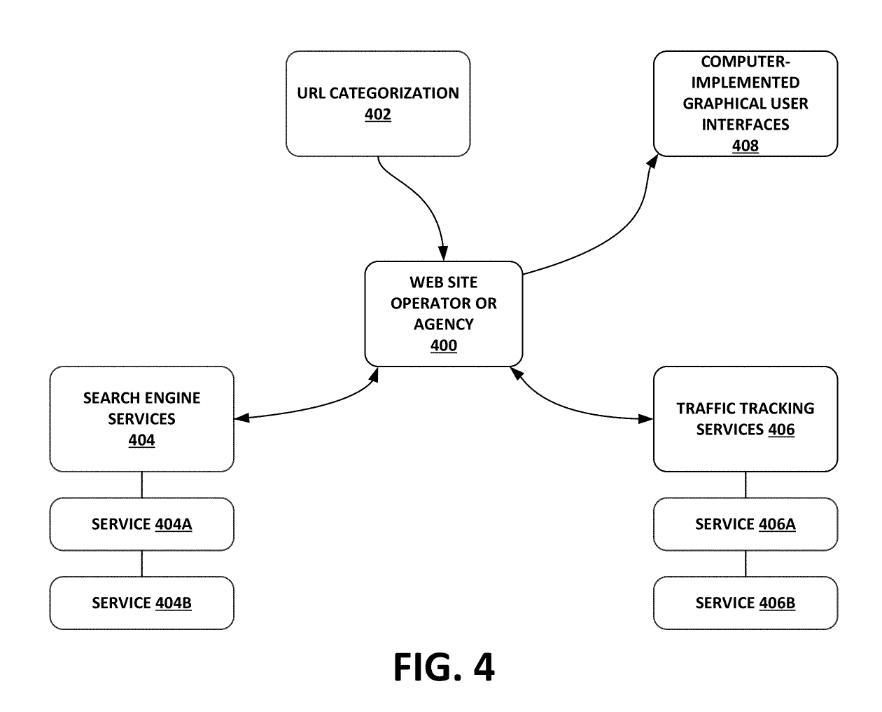

FIG. 4 depicts an SEO diagram, according to an example embodiment. In FIG. 4, web site operator or agency 400 may offer graphical user interfaces 408 that provide information related to SEO. The agency may have been hired by the web site operator for this purpose, and may also assist the web site operator with selecting target keywords and updating the design of the web site. Thus, throughout this disclosure, any actions attributable to the web site operator may be carried out by the web site operator itself, the agency, or both. Particularly, web site operator or agency 400 may simply be referred to as a “web site operator” or “web site operator 400.”

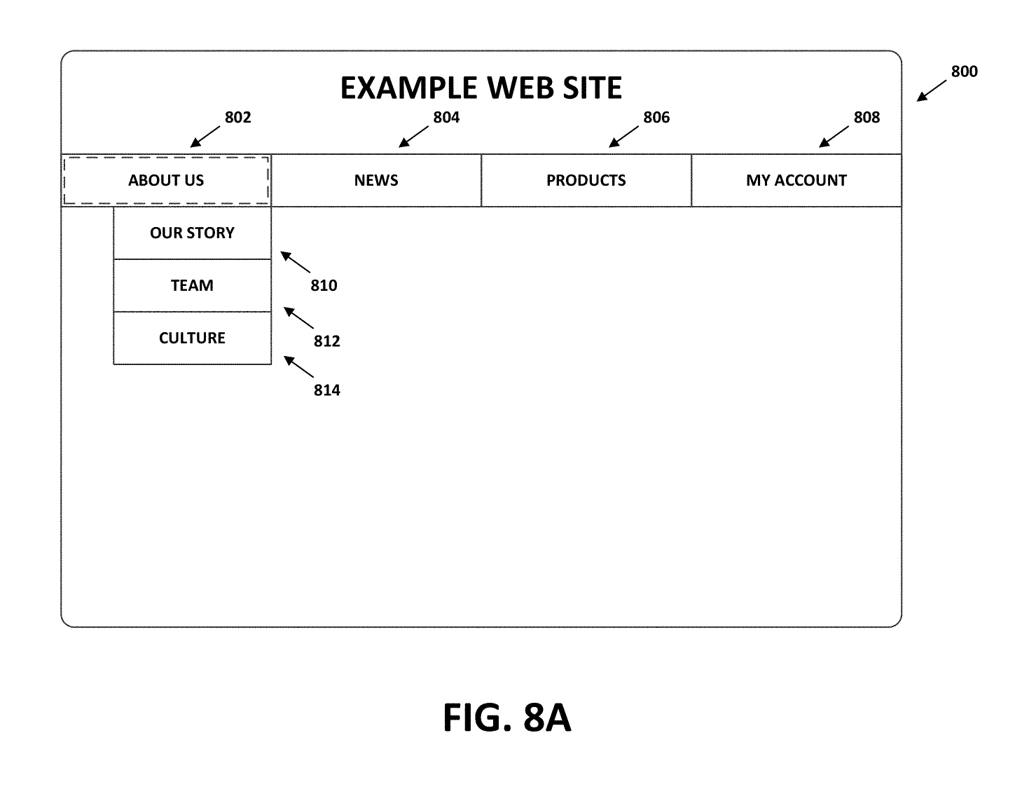

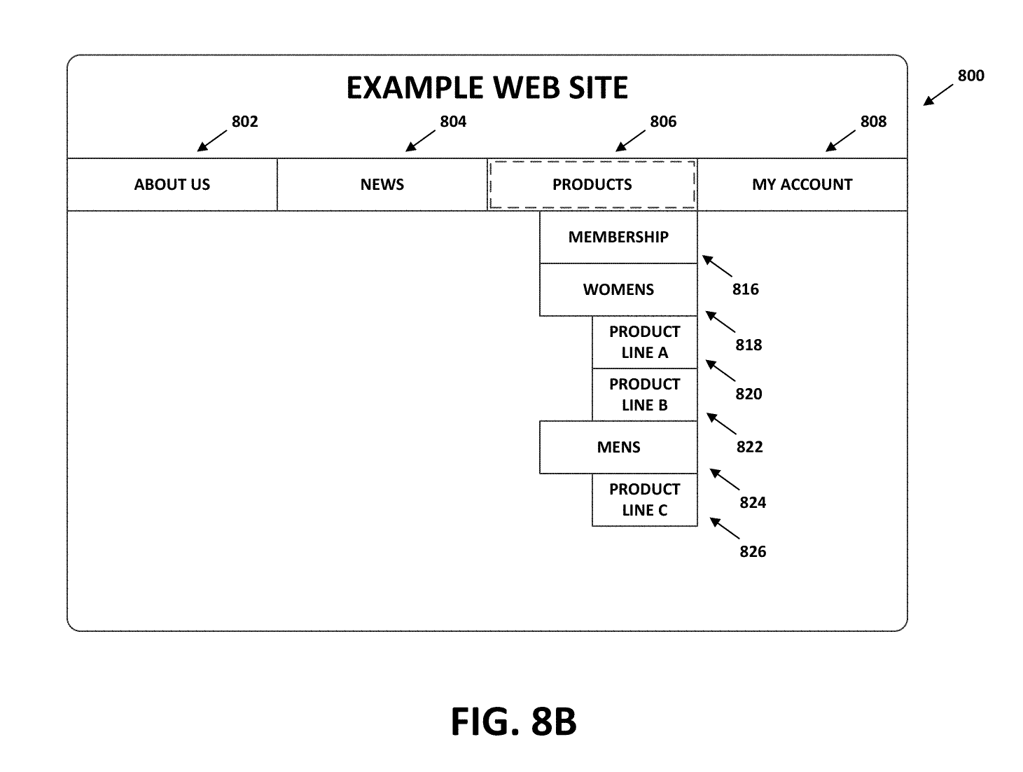

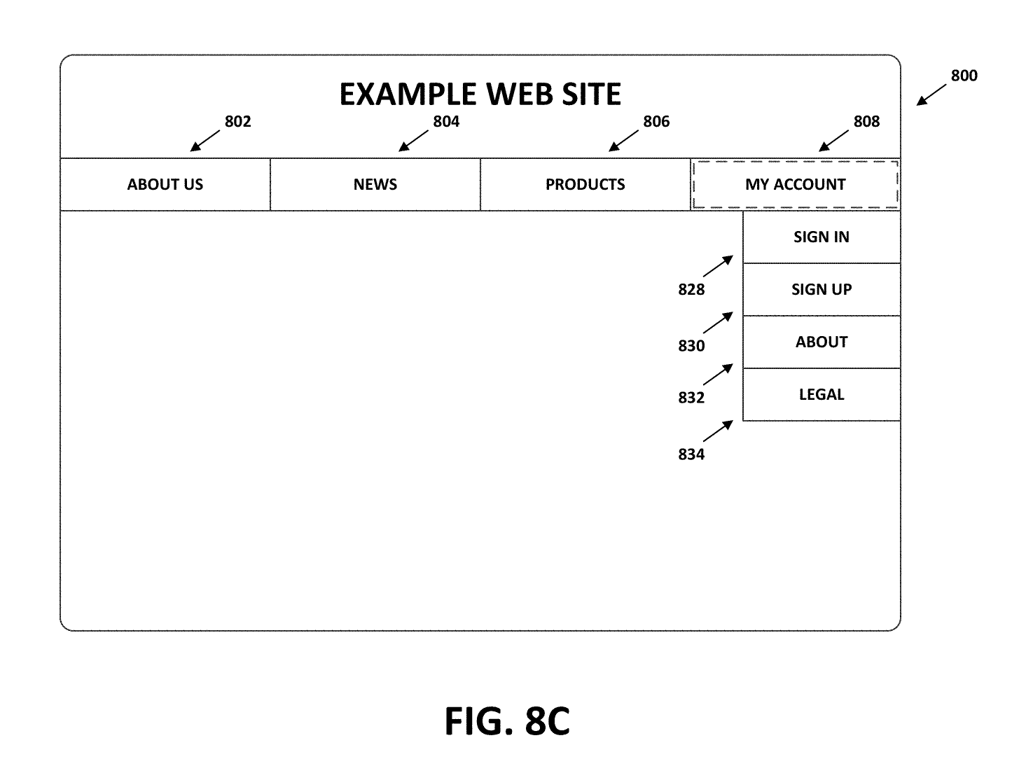

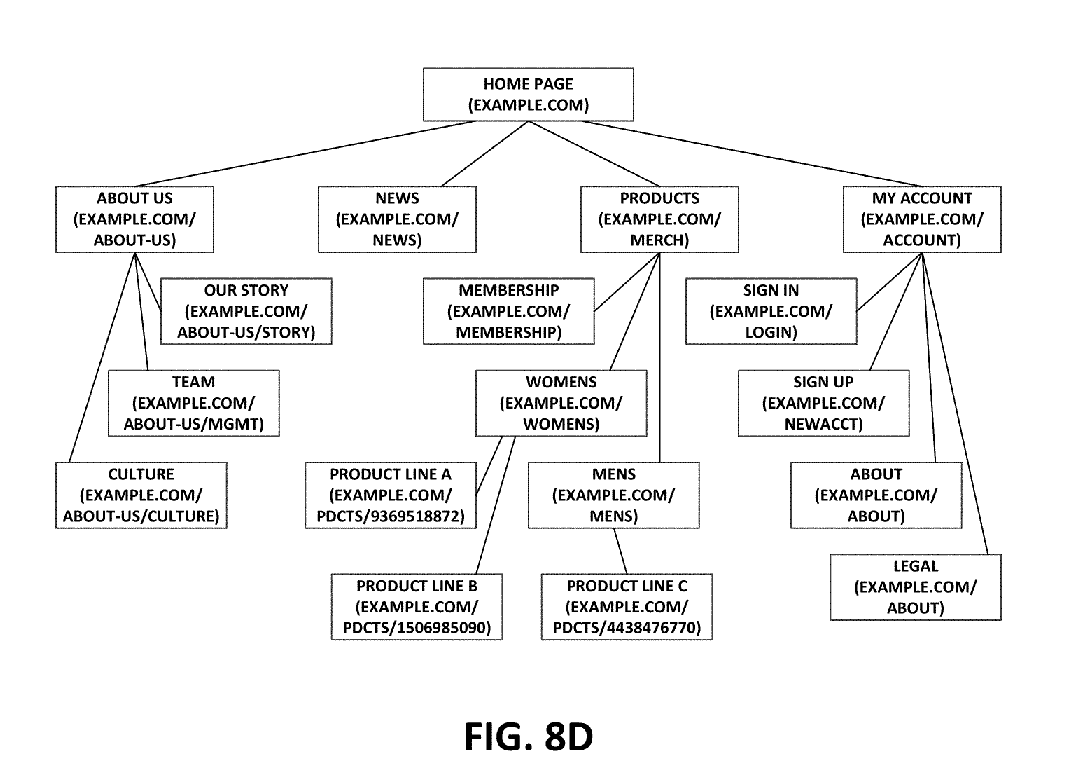

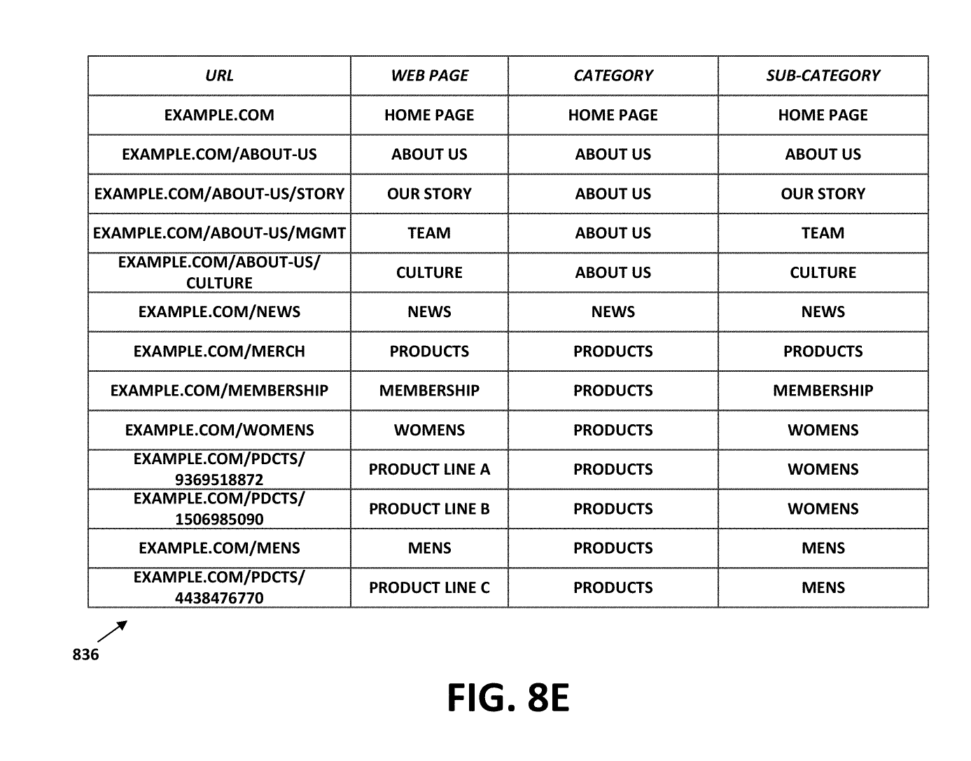

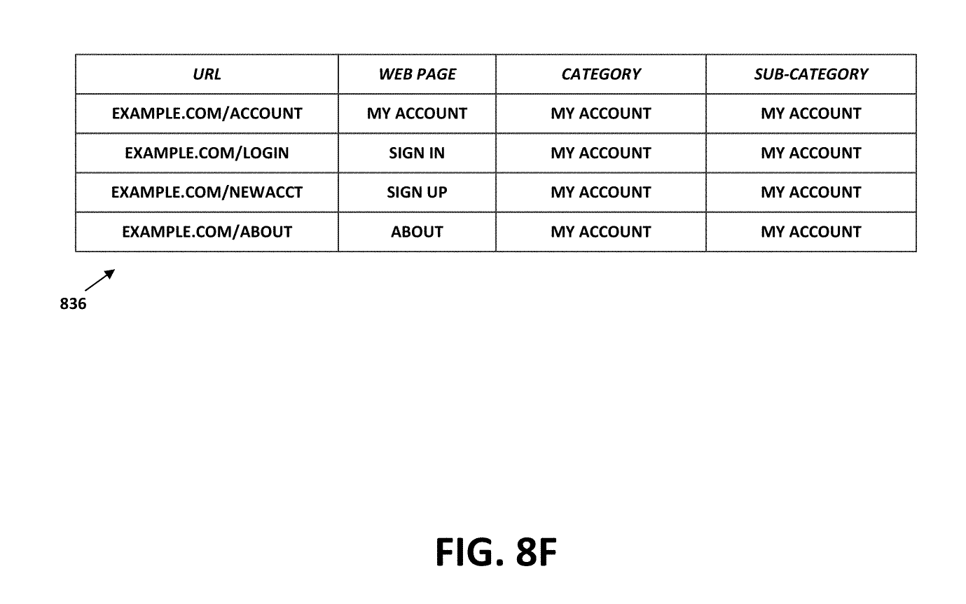

URL categorization 402 may be a database, spreadsheet, file, or some other representation of a mapping from the web pages of a web site (which may be represented by URLs) to categories and sub-categories. These categories and sub-categories may specify the type and/or content of the respective web pages, and may be based on the organization of the web site. FIGS. 8A-8E below provide an example URL categorization of web pages.

Search engine services 404 may be services available from a search engine provider. Example search engine providers include GOOGLE® and BING®—for instance, search engine service 404A may be GOOGLE® and search engine service 404B may be BING®. In addition to providing search services, these search engine providers may offer services that allow web site operator 400 to monitor and customize the presence of its web site in the associated search engine's results. An example of such a service is Google's Search Console.

By way of search engine services 404, web site operator 400 may be able to direct the search engine to the web site's content, submit new content to the search engine, and determine how frequently and how high web pages of the web site appear in search results. For instance, search engine services 404 may provide, per web page, information related to search impressions, clicks, click-through rate (CTR) and average position.

A search impression may be defined as when a URL referring to a particular web page appears in search results, whether or not that URL is viewed or clicked by a user. A click may be defined as when a URL referring to the particular web page appears in search results, and is clicked, touched, or otherwise selected by a user. The CTR of a web page may be calculated as the web page's impressions divided by its clicks. The average position of the web page may be defined as how high, on average, the URL appears in the search results (e.g., a position of 1 being the top result, a position of 2 being the second result, and so on).

Traffic tracking services 406 may include various types of analytics services that track and record user traffic. These may include web based analytics, application (or app) based analytics, phone call based analytics, and so on. Examples of traffic tracking services include GOOGLE® Analytics, ADOBE® Analytics, Linkdex keyword analysis, and INVOCA® call tracking.

As an example of web based analytics, a traffic tracking service (e.g., traffic tracking service 406A and/or 406B) may allow a web site operator to insert a unique tracking code into one or more of the web pages on a web site. This tracking code may be a snippet of JavaScript or some other programming language. The tracking code may be silently executed by the user's web browser when the user browses the page(s). The tracking code may collect information about the user (e.g., Internet Protocol (IP) address, and/or information about the user's web browser or computing device) and send this information to a traffic tracking service device. Additionally, the tracking code may set one or more browser cookies in the user's web browser. These cookies may store information such as whether the visitor has been to the site before, the timestamp of the current visit, and the referrer site that directed the visitor to the page (e.g., search engine, keywords, etc.).

As an example of phone based analytics, a web site operator's various web pages may be associated with one or more telephone numbers. More than one telephone number may be used so that specific keywords and web pages can be identified.

For instance, a web site operator may have two different web pages, each displaying a different telephone number (e.g., “vanity” numbers used only for this purpose). For instance, the web page may suggest that the reader call a respective phone number if the reader is interested in a particular product or service. Each phone number may be a specially assigned number that is only used for receiving calls related to the respective web page. Thus, each incoming phone call to a particular tracked phone number can be counted as a conversion. As an example, a traffic tracking service may provide software on a computer that receives the incoming call, identifies the associated web page, and records this information, perhaps with the caller's phone number. Then, the software may route the call to an agent who answers the call.

As another example, a traffic tracking service may track keyword use with respect to the web pages of a web site. For instance, a service like that of Linkdex may track a number of keywords of interest to the web site operator (e.g., “tracked keywords”), the number of top ten keywords associated with one or more web pages of the web site, the rankings of these keywords, and the total number of searches that included one or more of the keywords of interest.

Web site operator 400 may continuously or repeatedly retrieve, from search engine services 404 and traffic tracking services 406, information related to search engine performance as well as information related to traffic at a web site. This information may be presented in various ways on computer-implemented graphical user interfaces 408, some of which are described below. Since some of this information (e.g., visits and/or conversion) can change minute to minute (or even more frequently), web site operator 400 may continuously, periodically, or from time to time, retrieve updated representations of these values. In some cases, the retrieval may take place every 1, 2, 5, 10, 15, 20, 30 or 60 minutes, once per every one or more hours, or randomly. With this updated information, computer-implemented graphical user interfaces 408 may be revised accordingly to reflect the information.

Continuous retrieval of this information may involve a computing device affiliated with web site operator 400 retrieving the information from search engine services 404 and traffic tracking services 406 at a particular time. When that retrieval completes, the computing device may initiate another such retrieval. Alternatively, the computing device may wait a period of time (e.g., a few seconds or minutes) before initiating a subsequent retrieval.

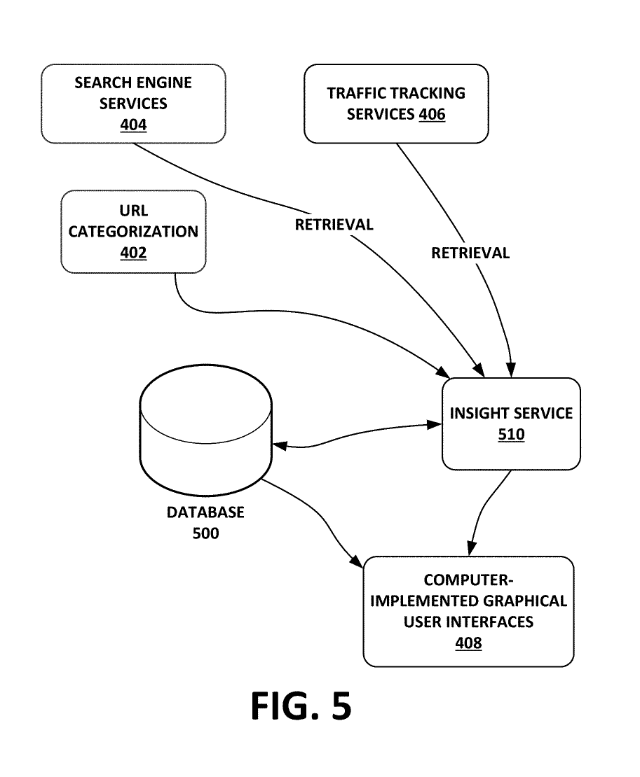

FIG. 5 depicts an architecture for SEO performance tracking. FIG. 5 provides another view of the embodiments discussed in the context of FIG. 4.

In FIG. 5, search engine services 404 and traffic tracking services 406 provide information related to search engine performance as well as information related to traffic at a web site, respectively. This information may be accessible via respective computing devices. Additionally, URL categorization 402 may be pre-defined for a web site.

Insights service 510 may be software that operates on another computing device, and may retrieve information from search engine services 404 and traffic tracking services 406. As noted above, this retrieval may take place periodically or from time to time. Insights service 510 may transmit representations of this information to database 500. Database 500 may store these representations, as well as previously-received representations of the information. Further, URL categorization 402 also may be incorporated into database 500. Based on aspects of this data, database 500 and/or insights service 510 may generate computer-implemented graphical user interfaces 408.

One of the advantages of graphical user interfaces 408 is that a vast amount of per-URL and per-web-page keyword, impression, and conversion information can be viewed per category and per-sub-category. In doing so, various aspects of performance for discrete sections of the web site can be rapidly attained. Furthermore, this information can be compared day-to-day, week-to-week, month-to-month and so on to identify trends. In response, the web site operator may change the content or performance of the web site.

### 4. EXAMPLE KEYWORD, SEARCH RESULTS, AND WEB PAGE RELATIONSHIPS

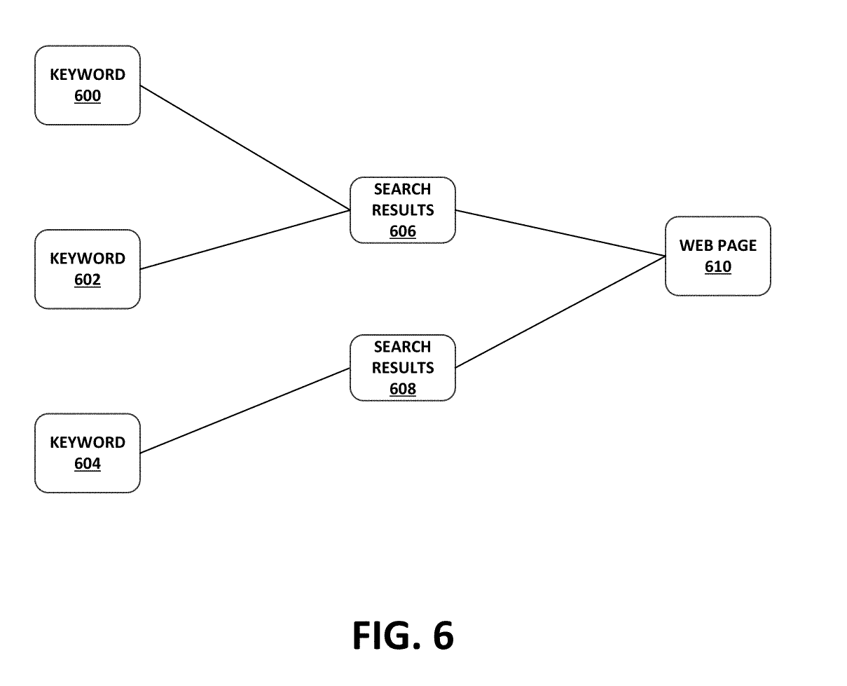

The relationships between keywords, search results, and web pages are illustrated in FIG. 6. When a user enters keywords 600 and 602 into a search engine, search results 606 is returned. Likewise, when a user enters keyword 604 into the search engine, search results 608 is returned. Both search results 606 and 608 include a URL referring to web page 610. Thus, if a user to which search results 606 or 608 is displayed clicks on, touches, or otherwise activates this this URL, the user may be redirected to web page 610 (e.g., a click-through has occurred). In most cases, web page 610 contains information relevant to keywords 600, 602, and 604. However, the URL for web page 610 may appear in different locations in search results 606 and 608. For instance, the URL may be at position 3 in search results 606, and at position 15 in search results 608.

As an example, web page 610 may contain information about automobiles and cars. For instance, web page 610 may be the main web page of a car dealership, or a web page of the car dealership that displays information about a current sale taking place. In these cases, keywords 600, 602, and 604 may be the terms “auto”, “automobile”, and “car”, respectively.

Web site operators would like to have their URLs associated with certain keywords. But they are usually competing with other web sites for this privilege, and the search engine service ultimately decides which URLs are associated with which keywords and where in the search results for the keywords each of these URLs is positioned. Factors that impact the position includes, but are not limited to: (i) how contextually relevant the web page's content is to the keyword, (ii) the web page's ease of navigation, and loading times, (iii) geographic relevance, and/or (iv) how well the web page performs when viewed on different types of client devices, such as personal computers, tablets, smartphones, etc. Other factors may be used as well as or instead of any of these factors.

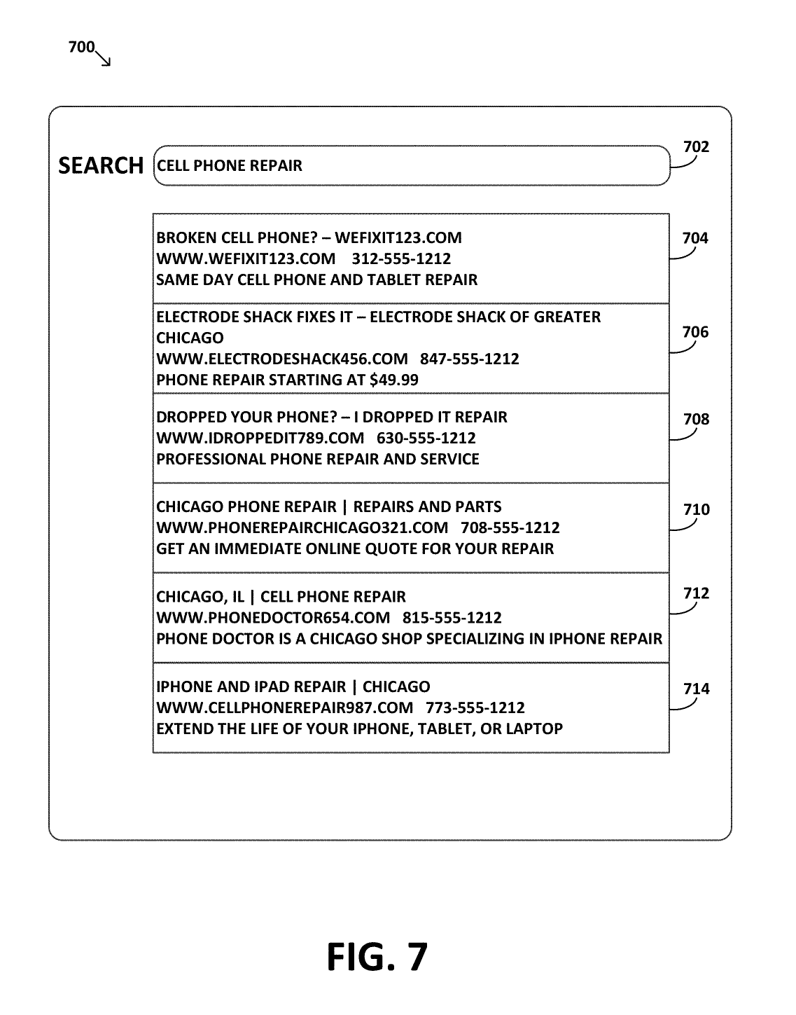

An example of search results is shown in FIG. 7. This figure features display 700 that includes text search box 702, and ranked search results 704, 706, 708, 710, 712, and 714. Display 700 may be a web-based search engine interface, but other types of search interfaces may be used as well.

Text search box 702 includes a keyword in the form of a text string (“cell phone repair”) that has been entered by way of a client device. This keyword may be transmitted to a remote search engine server which then identifies search results related to the keyword for display, and transmits these results back to the client device. In some cases voice search may be supported, where a user speaks a keyword into a microphone of a device, the spoken audio is converted to text, and search results for this text are provided.

Each of search results 704, 706, 708, 710, 712, and 714 provide three lines of text including a description of a business, a URL and phone number of the business, and a brief description of the products and/or services offered. For example, search result 706 is for the business “Electrode Shack” that has a web site at the URL www.electrodeshack456.com, has a phone number of 847-555-1212, and offers phone repair starting at $49.99.

When identifying search results related to the keyword, the search engine server may consider the keyword itself, various contexts of the keyword, and potentially other factors, such as attributes, characteristics, and/or preferences the client device's user, location of the client device, and so on. For instance, search results 706, 710, 712, and 714 each are explicitly related to Chicago-based businesses, and all listed search results are associated with phone numbers with a Chicago area code. This may be due to the client device being in the vicinity of Chicago.

The search results of FIG. 7 are implicitly ranked. Search result 704 is the top search result, with a position of 1. Search result 706 is the second highest search result, with a position of 2. Remaining search results 708, 710, 712, and 714 are ranked accordingly.

It is desirable for a web page to be ranked at or near the top of the search results for one or more keywords. Search engines tend to supply a limited number of search results at a time—perhaps 10 per results page. Since it is known that users often do not look beyond the first page of search results, web site operators may prefer to have their web pages listed in the top ten search results for the one or more keywords. When a web page has such a ranking, it may be referred to as having a “top ten keyword”. (This term of art is something of a misnomer as the web page is what is actually ranked rather than the keyword.)

### 5. EXAMPLE MAPPING OF WEB SITE STRUCTURE AND URLs TO A CATEGORIZATION

FIGS. 8A-8F provides an example mapping of a web site structure and URLs to a categorization. The embodiments illustrated by these figures and described herein use a two-level categorization—all web pages and their associated URLs are placed into a category and sub-category. Other mappings may be used however, including mappings with just one level of categorization, or with three or more levels of categorization (e.g., including sub-sub-categories, sub-sub-sub-categories, and so on). URL categorization 402 may contain such a mapping.

FIG. 8A depicts a layout of example web site 800. The web site may be, for instance, an ecommerce site that allows users to view and purchase products specifically targeted to male or female demographics. The layout represents a web page that a user might view when accessing example web site 800 from his or her client device. For instance, the header of the web page includes the text “Example Web Site”, below which four menu options are present: About Us 802, News 804, Products 806, and My Account 808.

Each of these menu options may include links that can be activated by the user. In some cases, if the user selects, clicks on, or hovers a cursor or pointer over a menu option (these actions being generally referred to as “selecting” herein), the user's client device might may request and receive a new web page or additional components for the currently-displayed web page, which may then be rendered for presentation to the user. In other cases, selecting a menu option may result in the web page displaying additional sub-options. In some embodiments, selecting the About Us 802, Products 806, and My Account 808 options result in respective sub-options being displayed, while selecting the News 804 option resulting in the requesting and reception of a new web page or additional components for the currently-displayed web page.

But, for purposes of discussion, it is assumed that each menu option discussed in the context of FIGS. 8A-8F is associated with a unique web page. Thus, as noted above, selecting any of these options results in the requesting and reception of the new web page. However, in some embodiments, selecting (e.g., hovering over) one or more of these options may result in further options being displayed without a new web page being requested and received.

In FIG. 8A, the menu option About Us 802 has been selected, and sub-options Our Story 810, Team 812, and Culture 814 are shown. Like menu options About Us 802, News 804, Products 806, and My Account 808, selecting any of these sub-options may result in the user's client device requesting, receiving, and displaying a new web page, additional components for the currently-displayed web page being displayed, and/or further options being displayed.

In FIG. 8B, the menu option Products 806 has been selected, and sub-options Membership 816, Womens 818, Product Line A 820, Product Line B 822, Mens 824, and Product Line C 826 are shown. While Product Line A 820, Product Line B 822, and Product line C 826 are depicted as the sub-options, in some embodiments Product Line A 820 and Product Line B 822 may be sub-sub-options of Womens 818, and Product Line C may be a sub-sub-option of Mens 824. Product line A 820 and Product line B may refer to, for example, two brands of women's clothing, while product line C may refer to a brand of men's clothing. Like menu options About Us 802, News 804, Products 806, and My Account 808, selecting any of these sub-options may result in the user's client device requesting, receiving, and displaying a new web page, additional components for the currently-displayed web page being displayed, and/or further options being displayed.

In FIG. 8C, the menu option My Account 808 has been selected, and sub-options Sign In 828, Sign Up 830, About 832, and Legal 834 are shown. Like menu options About Us 802, News 804, Products 806, and My Account 808, selecting any of these sub-options may result in the user's client device requesting, receiving, and displaying a new web page, or additional components for the currently-displayed web page being displayed, and/or further options being displayed.

FIG. 8D depicts a tree-like representation of the organizational structure of web site 800, along with URLs for each page. Each level in the tree represents a navigational distance between the pages in that level and the home page (example.com). For instance, the root of the tree is the home page (example.com) with a navigational distance of zero to itself.

The first level below the root level contains webpages for each of the About Us 802, News 804, Products 806, and My Account 808 options. Therefore, in this embodiment, selecting one of these options results in a new web page (example.com/about-us, example.com/news, example.com/merch, and example.com/account, respectively) being loaded and displayed. These webpages are a navigational distance of one from the home page.

The second level below the root level contains further webpages. For example, under the Products 806 option are the Membership 816, Womens 818, and Mens 824 options. Selecting one of these options results in a new web page (example.com/membership, example.com/womens, and example.com/mens, respectively) being loaded and displayed. These webpages are a navigational distance of two from the home page, though in some embodiments this navigational distance may be one. For instance, if the user selecting the Products 806 option does not result in a new web page being loaded, but the Membership 816, Womens 818, and Mens 824 options are shown, then selection of one of these second level options may take place directly from the display of the home page.

The third level below the root level contains also further webpages. For example, under the Womens 818 and Mens 824 options are the Product Line A 820, Product Line B 822, and Product line C 826 options. Selecting one of these options results in a new web page (example.com/pdcts/9369518872, example.com/pdcts/1506985090, and example.com/pdcts/4438476770, respectively) being loaded and displayed. These webpages are a navigational distance of three from the home page, though in some embodiments this navigational distance may be one or two. For instance, if the user selecting the Womens 818 option does not result in a new web page being loaded, but the Product Line A 820 and Product Line B 822 options are shown, then selection of one of these third level options may take place directly or one navigational step away from the display of the home page.

The mapping of URL structure to web site structure may vary. In some cases, the URL structure and web site structure may be similar, while in others it can be quite different. For instance, under the About Us 802 option, all of the second-level webpages have the same URL prefix (example.com/about-us). However, second-level web pages have URL suffixes that might or might not track their web page names. For instance, Culture 814 has a URL with a suffix of “culture”, while Our Story 810 has a suffix of “story”, and Team 812 has a suffix of “mgmt”. Furthermore, under the Products 806 option, Membership 816, Womens 818, and Mens 824 options only share the same domain name in their common URL prefix, while Product Line A 820, Product Line B 822, and Product line C 826 all have URL prefixes of “example.com/pdcts/” even though this prefix is not assigned to any particular option or web page. Moreover, under the My Account 808 option, About 832 and Legal 834 share the same URL (example.com/about).

As represented in these examples, the relationships between URLs and web page names can be arbitrary. Thus, creating a mapping between these items, as is shown in FIGS. 8E and 8F, can be a helpful way of clarifying such relationships.

Particularly, FIGS. 8E and 8F depicts table 836 that includes the aforementioned mappings between URLs and web pages, and also maps each URL to a category and sub-category. The mapping to categories and sub-categories may also be arbitrarily defined, or may follow (at least to some extent) the logical structure of the web site. Table 836 is an example of embodiment of URL categorization 402.

For instance, in FIG. 8E, the About Us 802 web page and all second-level web pages below are placed in the category “About Us”, and are also placed into unique sub-categories. On the other hand, the Products 806 web page and all second-level web pages below are placed in the category “Products”. However, each of these web pages is further mapped into one of the sub-categories “Products”, “Membership”, “Womens”, and “Mens”. Further, as shown in FIG. 8F, the My Account 808 web page and all second-level web pages below are placed into the same category and sub-category.

The mappings shown in FIGS. 8E and 8F can be arranged in a somewhat arbitrary fashion. Web site operators can arrange web pages into whatever categories and sub-categories that fit their business needs.

### 6. EXAMPLE GRAPHICAL USER INTERFACES

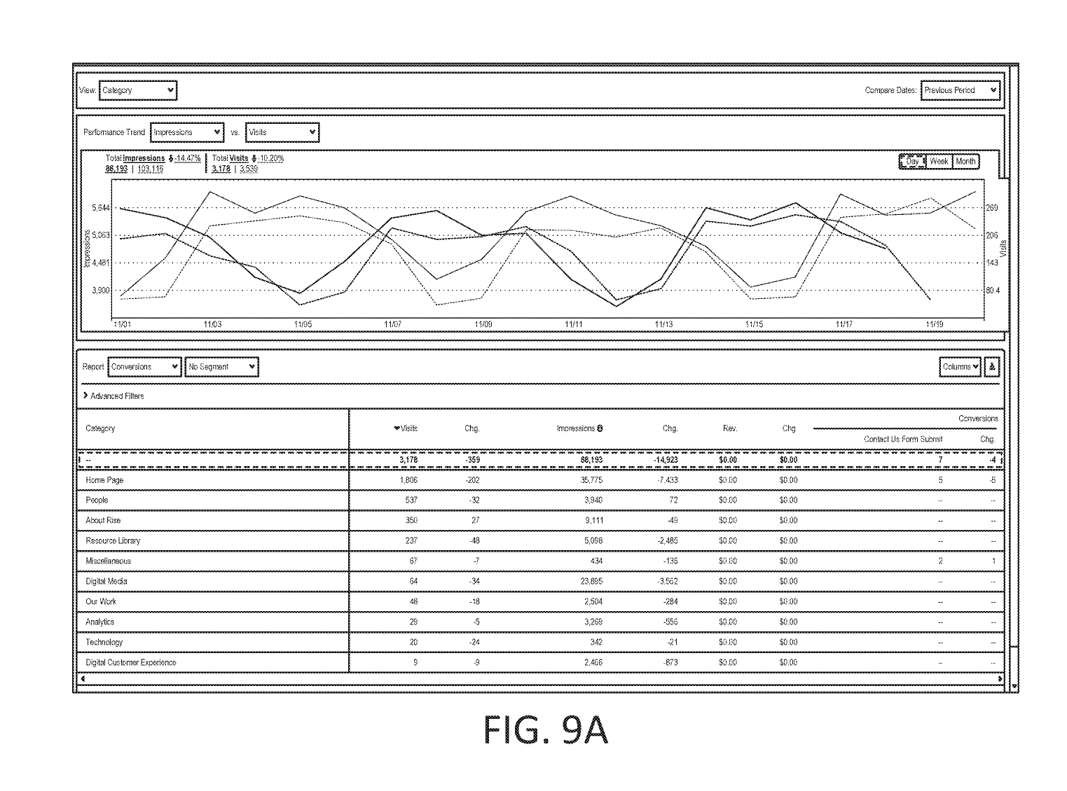

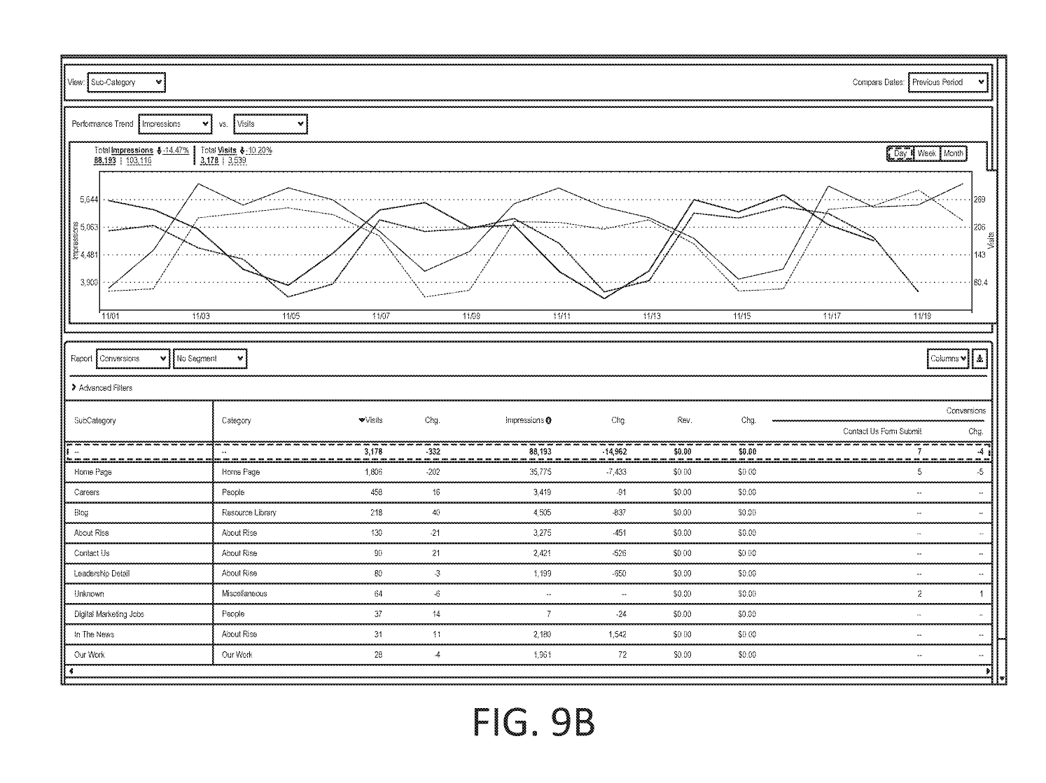

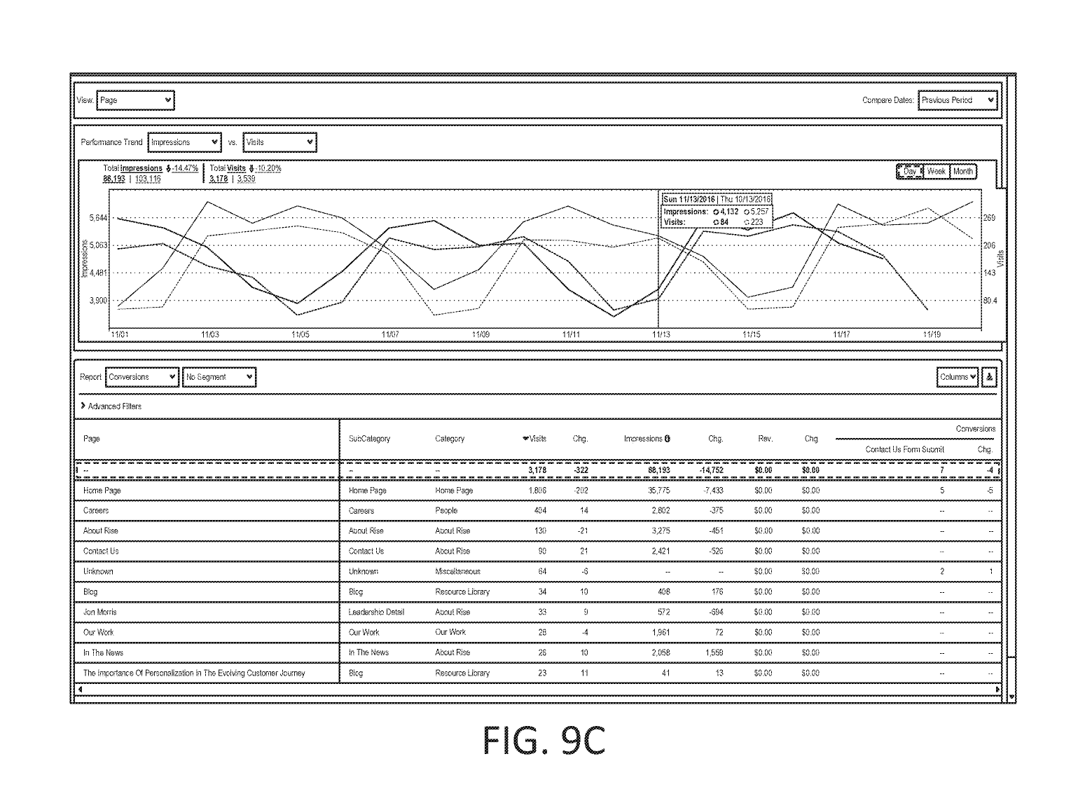

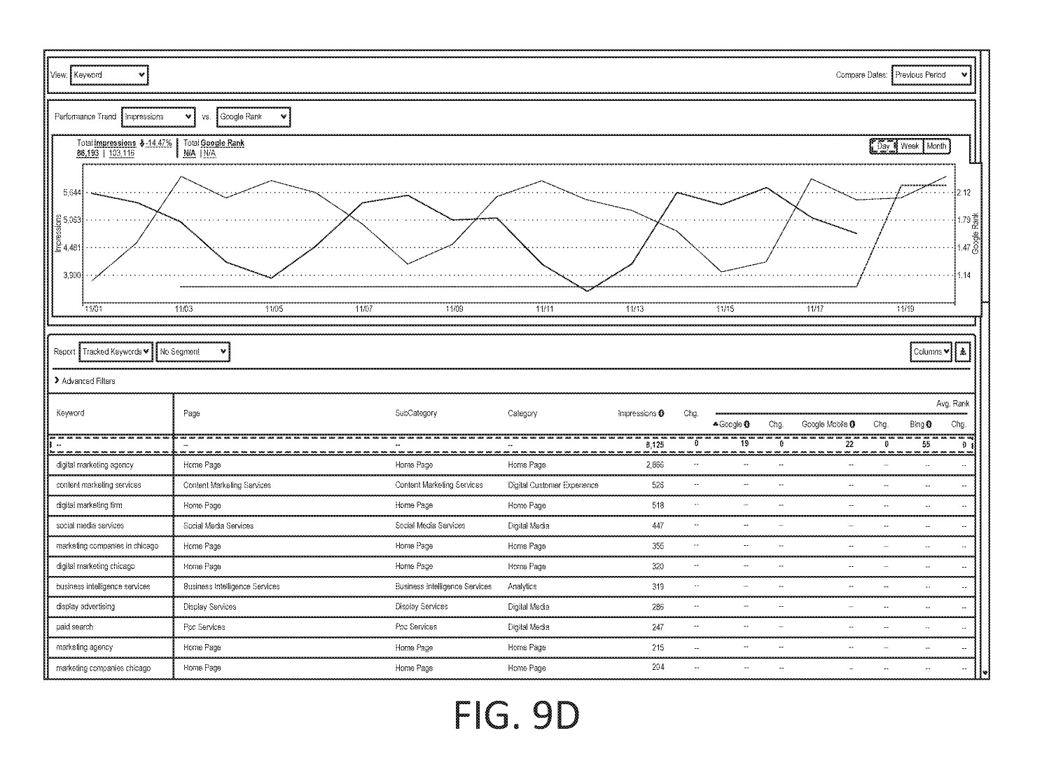

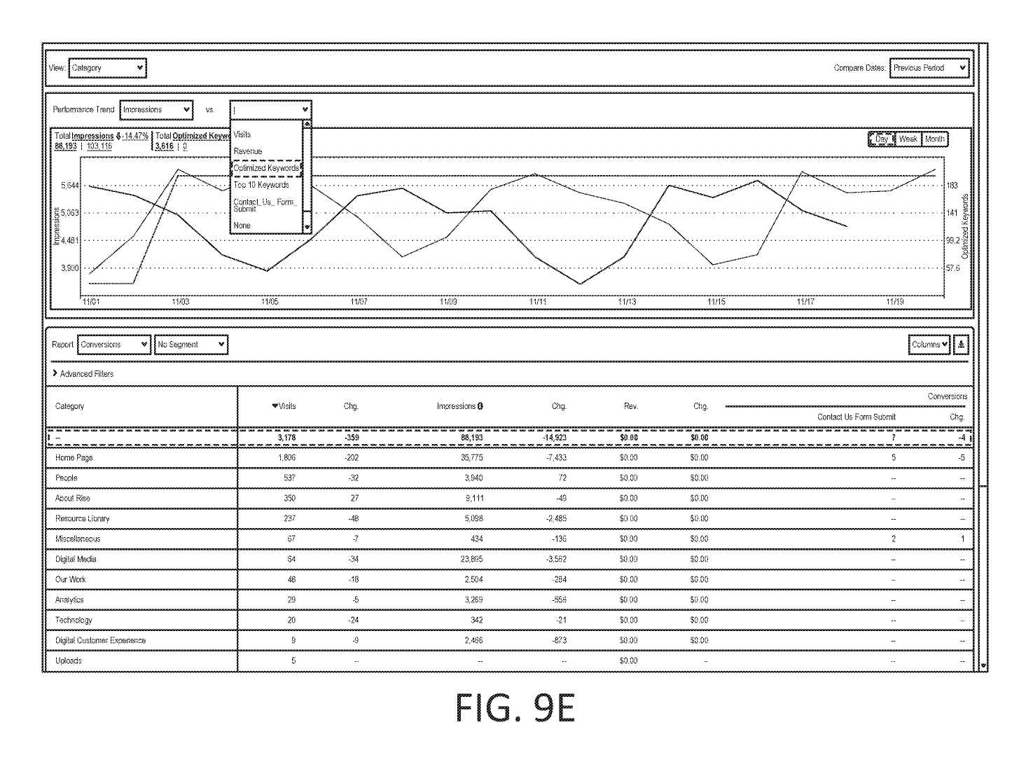

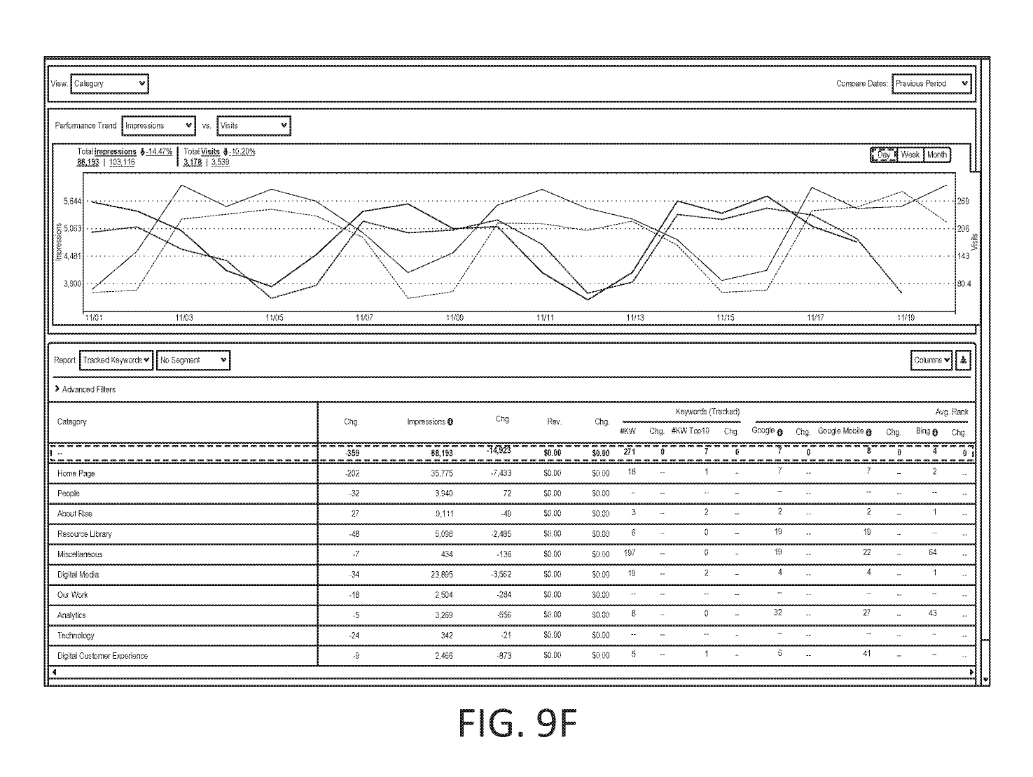

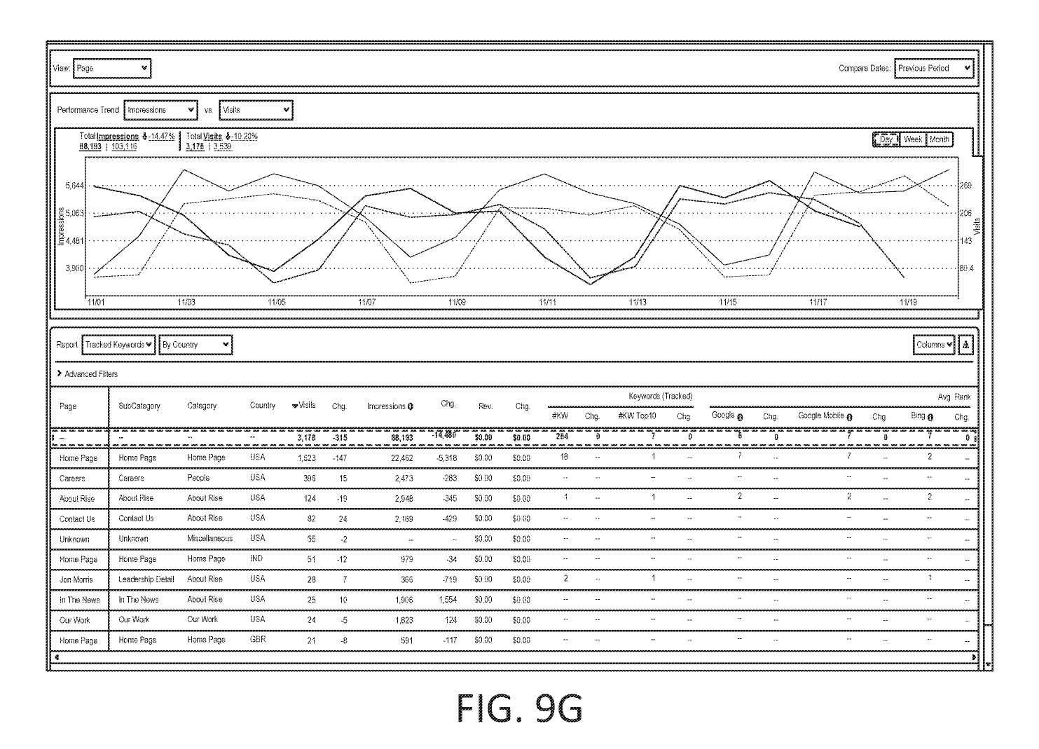

FIGS. 9A-9G depict graphical user interfaces, in accordance with example embodiments. Each of these graphical user interfaces may be provided for display on a client device. The information provided therein may be derived, at least in part, from data stored in a database, such as database 500. Nonetheless, these graphical user interfaces are merely for purpose of illustration. The applications described herein may provide graphical user interfaces that format information differently, include more or less information, include different types of information, and relate to one another in different ways.

One of the difficulties that web site operators encounter is that it is challenging to be able to measure the search engine performance of their web sites at an aggregate level as well as down to the web page and keyword level. While these entities can track search impressions, visits, and keyword rank through various services, there currently is no way to track this information at the category and sub-category level, or to view this information in an integrated fashion that allows the web site operator to focus on performance metrics of interest. Additionally, search engine performance might vary based on search engine, as well as the type of device used to conduct searches.

The data for search impressions, visits, and keyword rank this data is currently provided by discrete and different services. The web site operators may be simultaneously managing hundreds or thousands (or even more) web pages on one or more web sites. Thus, the amount of data maybe overwhelming. As a consequence, technical tools are required to be able to filter and process this data so that it can be presented in a manageable fashion on one or more configurable graphical user interfaces. Doing so may provide insights into the mechanics of SEO that would otherwise be unavailable.

Notably, the embodiments herein require computer implementation. By its very nature, SEO is premised on the existence of computers and computer networks. Billions of people around the world, accessing the Internet or private networks in various ways, may be visiting web sites. Tracking the performance of these web sites in various search engines, such as the associated number of search impressions, visits, and keyword ranks, occurs on computers that are connected via networks.

Further, there are no non-computerized analogies for such activities. Thus, the solutions presented herein a specifically designed to solve technical problems related to SEO. Moreover, these solutions may take the form of graphically user interfaces that present information that is filtered and organized so that a web site operator can rapidly determine the status of a large number of web pages. These graphical user interfaces automatically provide intuitive and insightful reports that would not be possible to otherwise obtain.

Non-limiting examples of such graphical user interfaces are described below. Nonetheless, these examples are made for purpose of illustration, and other graphical user interfaces, and layouts of information therein, may be possible.

FIG. 9A depicts an SEO insights graphical user interface. The graphical user interface includes a chart above a table. Both the chart and table provide insight into the performance of SEO for one or more web sites. In subsequent figures, variations of the chart and table are depicted separately for purposes of simplicity. However, any combination of a chart and a table can be placed into a single graphical user interface, in the fashion depicted in FIG. 9A or differently. In some embodiments, the information displayed on the chart and the table may be related, e.g., such that selection of an option for one of the chart or the table impacts the information displayed in both.

The chart portion of graphical user interface includes the chart, a view selector, two metrics (“performance trend”) selectors, and date range comparison selector (shown with “previous period” selected). In various embodiments, other information may be displayed on or omitted from a chart of the graphical user interface, and the displayed information can be arranged differently than depicted in FIG. 9A. For instance, in FIGS. 9B-9G, different example displays of such information are provided.

The table portion of the graphical user interface includes a table, a report type (“report”) selector, a segment selector, a column selector, and an advanced filter selector. The table may include a header row (depicted in FIG. 9A with “Category”, “Visits” and so on), a table summary row (depicted in FIG. 9A as the row immediately below the header row), and one or more table entry rows (depicted in FIG. 9A as below the table summary row). In various embodiments other information may be displayed on or omitted from a table of the graphical user interface, and the displayed information can be arranged differently than depicted in FIG. 9A. For instance, in FIGS. 9B-9G, different example displays of such information are provided.

The following subsections provide non-limiting descriptions of each of the components of the graphical user interface.

A. View

The view selector may be a drop down menu that allows a user to specify a type of view to be displayed on the graphical user interface. The selected view may impact the chart and/or the table. For instance, in FIG. 9A, the category view is selected. This selection determines the types of metrics selectors available for the chart, as well as the layout of the table.

For instance, in FIG. 9A, the metrics selectors include impressions (search impressions) and visits, with other metrics available (see below). Further, selecting the category view results in the table being organized with one table entry row per category.

Another view is the sub-category view, depicted in FIG. 9B. In this example, the metrics available are the same as that of the category view, but the table is organized with one table entry row per sub-category.

Yet another view is the page (web page) view, depicted in FIG. 9C. In this example, the metrics available are the same as that of the category view, but the table is organized with one table entry row per web page.

Still another view is the keyword view, depicted in FIG. 9D. In this example, the metrics available include impressions and GOOGLE® rank (e.g., an aggregate search ranking of web pages of the web site for a particular set of keywords), and the table is organized with one table entry row per keyword.

The depicted views are merely for purpose of illustration. Other views may be available, and such views may have different impacts on the metrics available and the table layout.

B. Metrics

Metric selectors may be drop down menus or other types of selectors that each allow a user to select a metric related to paid search advertising. In the embodiment depicted in FIG. 9A, the left metric selector controls the metric used for the left y-axis of the chart, and the right metric selector controls the metric used for the right y-axis of the chart.

For instance, the left metric selector depicts the metric impressions as selected, and impressions is the unit used for the left y-axis of the chart. Similarly, the right metric selector depicts the metric visits as selected, and visits is the unit used for the right y-axis of the chart. Other possibilities exist.

In some embodiments, the metric selectors may be configured so that the metric selected for one is not available for selection to the other. For instance, if impressions is the metric selected for the left metric selector, then impressions might not be available for selection by way of the right metric selector.

Each metric selector may display any metric discussed herein, including those described in the previous sections. These may include impressions, visits, revenue, optimized (tracked) keywords, top ten keywords, average keyword rank, and/or a customized conversion metric. Other metrics are possible.

As an example, FIG. 9E displays a drop down menu showing a list of selectable metrics for the right metric selector. Optimized keywords is shown as selected, while visits, revenue, top ten keywords and a customized conversion metric are available for selection. The scroll bar on the right side of the drop down menu may be able to be slid downward to reveal further selectable metrics. A similar drop down menu may be implemented for the left metric selector.

A customized conversion metric may be a conversion metric that is specific to a particular web site. For instance, in FIG. 9E, the metric “Contact Us Form Submit” may relate and/or measure to the number of times that a particular web-based form on the web site was submitted. Other customized conversion metric, such a file downloads and video views may exist.

C. Date Range Comparison

The date range comparison selector may be a drop down menu or another type of selector that allows a user to select a particular a time period with which to compare metrics on the chart. For instance, the drop down menu selections may be previous period, which may result in a display of the metrics for the date range of the date range selector depicted in FIG. 9A. This selection may result in a display of the metrics for the date range of a current period as well as the metrics for a similar date range from a previous time period. For instance, as shown in FIG. 9A, the date range displayed on the chart is Nov. 1-20, 2016, as shown on the x-axis of the chart. Since previous period is selected for the date range comparison selector, metrics for Oct. 1-20, 2016 may be overlaid in the chart on top of or in addition to those for Nov. 1-20, 2016.

A further selectable period may be same time last year, which can result in a display of the metrics for the current date range as well as the metrics for a similar date range from the preceding year. For instance, if same time last year is selected for the date range comparison selector, metrics for Nov. 1-20, 2015 may be overlaid on top of or in addition to those for Nov. 1-20, 2016.

D. Chart

The chart may display a chart or graph comparing the metrics selected using the two metric selectors. One possible implementation is shown in FIG. 9A where the chart is a double y-axis graph. The x-axis of this graph represents the days of a date range. The left y-axis represents impression, as determined by the left metric selector, and the right y-axis represents visits, as determined by the right metric selector.

Notably, the ranges of one or both the left and right y-axes are normalized so that these lines appear in approximately the same location of the chart. Overall this chart indicates that there is a strong correlation between the number of search impressions and web site visits for the specified time period.

Further, as shown in FIG. 9C, clicking on, hovering over, or otherwise selecting a date on the x-axis of the chart may result in a text box popping up displaying the values of the selected metrics for this date. For instance, the text box shown indicates that on Nov. 13, 2016, there were 4,132 search impressions and 84 visits.

E. Chart Granularity

The chart granularity selector may allow a user to select the amount of time represented by each point on the x-axis of the chart. For instance, FIG. 9A shows each such point representing one day. However, a granularity of a week or month may be selected instead. In some embodiments, when day is selected, each point on the x-axis of the chart may represent a day from the first of the current month until the current day (or until the day before the current day).

When week is selected, each point on the x-axis may represent a week from the first week of the current month until the current week (or until the week before the current week). When month is selected, each point on the x-axis may represent a month from the first month of the current year until the current month (or until the month before the current month). Any of these ranges may be further limited by the availability of data for the requested time period.

F. Table

The table displays a number of columns and rows. Each column may represent either a way in which SEO information can be categorized or identified. Each row may represent categories, sub-categories, web pages, keywords, or other organizations of advertising information. It may be possible, by way of the graphical user interface, to sort the rows in ascending or descending order based on the information displayed in one or more of the columns.

In some arrangements (e.g., for the category, sub-category, and page views), columns for categories, impressions, visits, revenue, and conversions may be included in the table. In other arrangement, sub-categories and web pages may be included. In further arrangements (e.g., for the keyword view), columns for keywords, and per-search-engine keyword performance (e.g., average rank, number of keywords, top ten keywords, and so on) may be displayed.

In some embodiments, change value columns (“Chg.”) for one more metrics may be displayed. Such change values may represent differences in the associated metric from one time period to the next. For instance, the change value columns of FIG. 9A compare current values to respective values of the previous period, as defined by the date range comparison selector.

G. Table Rows

As noted above, the table header row may represent column headers for each column displayed in the table, and the table summary row may represent a total or weighted total of the values represented in the following rows of the table.

For instance, the entry of the table summary row for the visits column includes a sum of the per-category visits of each entry (note that the table has been truncated for purpose of illustration; thus, the un-truncated version would contain addition rows with entries such that all of the entries total 3178.

The table entry rows may represent entries for each column in the table. For instance, in the category column of FIG. 9A, the first table entry row relates to web pages in the category of “Home Page”. Similarly, the second table entry row relates to web pages in the category of “People”.

H. Report Type

The report type selector may be a drop down menu or another type of selector that allows a user to select a particular predefined report for display in the table. The selected report type may determine, to some extent, the columns displayed in the table. A number of report types may be available, some of which are described below.

A conversions report type may provide information regarding certain categories, sub-categories, and/or web pages. An example of a conversions report type is shown in FIG. 9A.

A tracked keywords report type may provide information regarding certain keywords for each row in the table. An example of a tracked keyword report type is shown in FIG. 9F. As used herein, the term “tracked keywords” refers to keywords that the web site operator has specifically requested that one or more search engine or traffic tracking services track. In some cases, the terms tracked keywords and optimized keywords may be used synonymously.

In some embodiments, a sub-report type may also be available. For instance, FIG. 9G shows the result of displaying a “by country” sub-report type. Particularly, the SEO information for each web page is broken out per country.

I. Column Selector

The column selector may be a drop down menu or another type of selector that allows a user to select individual columns to display in the table. Some or all of the columns that appear in this table each may be associated with a metric described in the previous section.

J. Advanced Filters

The advanced filters selector may be a drop down menu or another type of selector that allows a user to either select a pre-determined filter term, or to enter a custom filter term. Pre-determined filter terms may include the names of any of the columns discussed herein, for example. Once a filter term is selected and applied, only rows including that filter term may be displayed.

### 7. EXAMPLE OPERATIONS

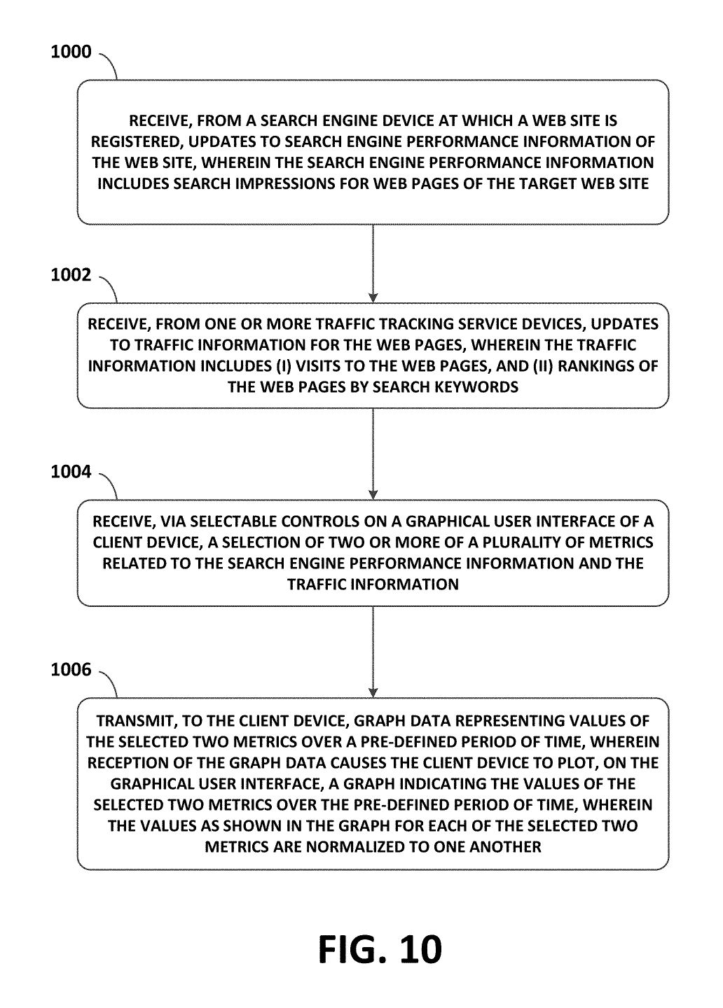

FIG. 10 is a flow chart illustrating an example embodiment. The process illustrated by FIG. 10 may be carried out by a computing device, such as computing device 200, and/or a cluster of computing devices, such as server cluster 304. However, the process can be carried out by other types of devices or device subsystems. For example, the process could be carried out by a portable computer, such as a laptop or a tablet device.

A. Receiving Updates to Online Advertisement Performance Information

Block 1000 may involve receiving, from a search engine device at which a web site is registered, updates to search engine performance information of the web site. The search engine performance information may include search impressions for web pages of the target web site.

These updates may be repeatedly received periodically or from time to time. For instance, the updates may be responsive to requests transmitted by the computing device carrying out the operations of block 1000. Alternatively or additionally, the search engine service device may be configured to repeatedly transmit the updates to the computing device.

In some embodiments, the updates to the search engine performance information are repeatedly received from the search engine device and a second search engine device. The search engine device and the second search engine device may be operated by different search engine providers.

B. Receiving Updates to Online Advertising Traffic Information

Block 1002 may involve receiving, from one or more traffic tracking service devices, updates to traffic information for the web pages. The traffic information may include (i) visits to the web pages, and (ii) rankings of the web pages by search keywords.

These updates may be repeatedly received periodically or from time to time. For instance, the updates may be responsive to requests transmitted by the computing device carrying out the operations of block 1002. Alternatively or additionally, the traffic tracking service device may be configured to repeatedly transmit the updates to the computing device.

In some embodiments, the one or more traffic tracking service devices include a first traffic tracking service device that tracks the visits to the web pages, and a second traffic tracking service device that tracks the rankings of the web pages by search keywords. The updates to traffic information for the web pages may be received from the first traffic tracking service device and the second traffic tracking service device.

C. Receiving a Selection of Metrics

Block 1004 may involve receiving, via selectable controls on a graphical user interface of a client device, a selection of two or more of a plurality of metrics related to the search engine performance information and the traffic information. In some cases, the selection of one or more of these metrics may be implicit—that is a metric can have a default value pre-selected, and the user “selects” this metric by leaving it at this default value. Further, it may be possible for only one metric to be selected, and the selection of this metric to cause the transmission of graph data as described below.

Nonetheless, the selected two metrics may involve the search impressions for the web pages, the visits to the web pages, revenue from the conversions that occur by way of the web pages, a total number of the search keywords, a number of the search keywords for which associated ones of the web pages appear on first pages of search results (e.g., top ten search results), and a conversion metric customized for the target web site.

D. Transmitting Graph Data to the Client Device

Block 1006 may involve, possibly in response to selection of the two metrics, transmitting, to the client device, graph data representing values of the selected two metrics over a pre-defined period of time. Reception of the graph data may cause the client device to plot, on the graphical user interface, a graph indicating the values of the selected two metrics over the pre-defined period of time.

The values as shown in the graph for each of the selected two metrics may be normalized to one another. For example, the ranges of values for each metric may be determined, and the scale of one or more dimensions of the graph may be adjusted to fit the respective ranges.

In some embodiments, the pre-defined period of time is a month-to-date period of time. An x-axis of the graph may contain entries for each day in the pre-defined period of time. In some embodiments, the graph represents the pre-defined period of time on an x-axis and represents each of the values of the selected two metrics on respective y-axes.

E. Transmitting Table Data to the Client Device

Some embodiments may involve, perhaps based on a pre-defined mapping of the web pages to categories and sub-categories, aggregating the search engine performance information and the traffic information from the web pages into the categories and the sub-categories. Each of the sub-categories may be respectively associated with one of the categories, and each of the web pages may be respectively associated with one of the sub-categories.

Such embodiments may further involve, possibly based on a reporting option, determining a subset of the search engine performance information and the traffic information. These embodiments may also involve transmitting, to the client device, table data representing values of the subset over the pre-defined period of time. Reception of the table data may cause the client device to display, on the graphical user interface, a table indicating the values of the subset over the pre-defined period of time. Columns and rows of the table are defined by the reporting option, and organize the table data by at least one of the web pages, the categories, or the sub-categories.

In some embodiments, the selectable controls include a category option. Selection of the category option may cause the table to include (i) a column that contains one row for each of the categories, and (ii) one or more additional columns that contain portions of the table data row-wise associated with the categories of the column.

In some embodiments, the selectable controls include a sub-category option. Selection of the sub-category option may cause the table to include (i) a first column that contains one row for each of the sub-categories, (ii) a second column that contains categories row-wise associated with the sub-categories of the first column, and (iii) one or more additional columns that contain portions of the table data row-wise associated with the sub-categories of the first column.

In some embodiments, the selectable controls include a web page option. Selection of the web page option causes the table to include (i) a first column that contains one row for each of the web pages, (ii) a second column that contains sub-categories row-wise associated with the web pages of the first column, (iii) a third column that contains categories row-wise associated with the sub-categories of the second column, and (iv) one or more additional columns that contain portions of the table data row-wise associated with the web pages of the first column.

In some embodiments, one or more search keywords are respectively related to the web pages. The selectable controls may include a search keyword option. Selection of the search keyword option causes the table to include (i) a first column that contains one row for each of at least some of the search keywords, (ii) a second column that contains web pages row-wise associated with the search keywords of the first column, (iii) a third column that contains sub-categories row-wise associated with the web pages of the second column, (iv) a fourth column that contains categories row-wise associated with the sub-categories of the third column, and (v) one or more additional columns of the table that contain portions of the table data row-wise associated with the search keywords of the first column.

Some embodiments may involve receiving, via the selectable controls on the graphical user interface, a selection of the reporting option. Determining the subset may be based on the reporting option as selected. Alternatively or additionally, the reporting option may be automatically selected based on the selected two metrics.

In some embodiments, the reporting option selected is a conversions-related reporting option. Selecting the conversions-related reporting option may cause the table to include a column that contains the conversions that occur by way of the web pages.

In some embodiments, the reporting option selected is a customized-conversions-related reporting option specific to one or more of the web pages. Selecting the customized-conversions-related reporting option may cause the table to include a column that contains customized conversions that occur by way of the one or more of the web pages.

In some embodiments, the graphical user interface includes a column selection control configured to change the columns of the table as displayed to user-defined selections. Alternatively or additionally, the graphical user interface may include a filter selection control that is configured to define a filter. The defined filter may be specified by an operation applied to a particular metric of the plurality of metrics, and the filter selection control, when applied, causes the table to be filtered based on the defined filter.

In some embodiments, the columns of the table include entries for the selected two metrics.

The embodiments of FIG. 10 may be simplified by the removal of any one or more of the features shown therein. Further, these embodiments may be combined with features, aspects, and/or implementations of any of the previous figures or otherwise described herein.

### 8. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including substantially concurrent or in reverse order, depending on the functionality involved. Further, more or fewer blocks and/or functions can be used with any of the ladder diagrams, scenarios, and flow charts discussed herein, and these ladder diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
repeatedly receiving, by a computing device and from a search engine device at which a web site is registered, updates to past search engine performance information of the web site, wherein the past search engine performance information includes search impressions for web pages of the web site;
repeatedly receiving, by the computing device and from one or more traffic tracking service devices, updates to past traffic information for the web pages, wherein the past traffic information includes (i) visits to the web pages, and (ii) rankings of the web pages by search keywords;
receiving, by the computing device via selectable controls on a graphical user interface of a client device, a selection of two or more of a plurality of metrics related to the past search engine performance information and the past traffic information;
transmitting, by the computing device and to the client device, graph data representing values of the selected two metrics over a pre-defined period of time, wherein reception of the graph data causes the client device to plot, on the graphical user interface, a graph indicating the values of the selected two metrics over the pre-defined period of time, wherein the values as shown in the graph for each of the selected two metrics are normalized to one another;
based on a pre-defined mapping of the web pages to categories and sub-categories, aggregating, by the computing device, the past search engine performance information and the past traffic information into the categories and the sub-categories, wherein each of the sub-categories is respectively associated with one of the categories, and wherein each of the web pages is respectively associated with one of the sub-categories;
based on a reporting option, determining, by the computing device, a subset of the past search engine performance information and the past traffic information; and
transmitting, by the computing device, table data representing values of the subset over the pre-defined period of time, wherein reception of the table data causes the client device to display, on the graphical user interface along with the graph, a table indicating the values of the subset over the pre-defined period of time, and wherein columns and rows of the table are defined by the reporting option, and organize the table data by at least one of the web pages, the categories, or the sub-categories.

2. The method of claim 1, wherein the selectable controls include a category option, wherein selection of the category option causes the table to include (i) a column that contains one row for each of the categories, and (ii) one or more additional columns that contain portions of the table data row-wise associated with the categories of the column.

3. The method of claim 1, wherein the selectable controls include a sub-category option, wherein selection of the sub-category option causes the table to include (i) a first column that contains one row for each of the sub-categories, (ii) a second column that contains categories row-wise associated with the sub-categories of the first column, and (iii) one or more additional columns that contain portions of the table data row-wise associated with the sub-categories of the first column.

4. The method of claim 1, wherein the selectable controls include a web page option, wherein selection of the web page option causes the table to include (i) a first column that contains one row for each of the web pages, (ii) a second column that contains sub-categories row-wise associated with the web pages of the first column, (iii) a third column that contains categories row-wise associated with the sub-categories of the second column, and (iv) one or more additional columns that contain portions of the table data row-wise associated with the web pages of the first column.

5. The method of claim 1, wherein search keywords are respectively related to the web pages, wherein the selectable controls include a search keyword option, wherein selection of the search keyword option causes the table to include (i) a first column that contains one row for each of at least some of the search keywords, (ii) a second column that contains web pages row-wise associated with the search keywords of the first column, (iii) a third column that contains sub-categories row-wise associated with the web pages of the second column, (iv) a fourth column that contains categories row-wise associated with the sub-categories of the third column, and (v) one or more additional columns of the table that contain portions of the table data row-wise associated with the search keywords of the first column.

6. The method of claim 1, further comprising:
receiving, via the selectable controls on the graphical user interface, a selection of the reporting option, wherein determining the subset is based on the reporting option as selected.

7. The method of claim 1, wherein the reporting option is automatically selected, by the computing device, based on the selected two metrics.

8. The method of claim 1, wherein the reporting option selected is a conversions-related reporting option, and wherein selecting the conversions-related reporting option causes the table to include a column that contains the conversions that occur by way of the web pages.

9. The method of claim 1, wherein the reporting option selected is a customized-conversions-related reporting option specific to one or more of the web pages, and wherein selecting the customized-conversions-related reporting option causes the table to include a column that contains customized conversions that occur by way of the one or more of the web pages.

10. The method of claim 1, wherein the graphical user interface includes a column selection control configured to change the columns of the table as displayed to user-defined selections.

11. The method claim 1, wherein the graphical user interface includes a filter selection control that is configured to define a filter, wherein the defined filter is specified by an operation applied to a particular metric of the plurality of metrics, and the filter selection control, when applied, causes the table to be filtered based on the defined filter.

12. The method of claim 1, wherein the columns of the table include entries for the selected two metrics.

13. The method of claim 1, wherein the pre-defined period of time is a month-to-date period of time, and wherein an x-axis of the graph contains entries for each day in the pre-defined period of time.

14. The method of claim 1, wherein the graph represents the pre-defined period of time on an x-axis and represents each of the values of the selected two metrics on respective y-axes.

15. The method of claim 1, wherein the selected two metrics are selected from the group consisting of: the search impressions for the web pages, the visits to the web pages, revenue from the conversions that occur by way of the web pages, a total number of the search keywords, a number of the search keywords for which associated ones of the web pages appear on first pages of search results, and a conversion metric customized for the target web site.

16. The method of claim 1, wherein the updates to the past search engine performance information are repeatedly received from the search engine device and a second search engine device, wherein the search engine device and the second search engine device are operated by different search engine providers.

17. The method of claim 1, wherein the one or more traffic tracking service devices include a first traffic tracking service device that tracks the visits to the web pages, and a second traffic tracking service device that tracks the rankings of the web pages by search keywords, and wherein the updates to the past traffic information for the web pages are repeatedly received from the first traffic tracking service device and the second traffic tracking service device.

18. An article of manufacture including a non-transitory computer-readable medium, having stored thereon program instructions that, upon execution by a computing device, cause the computing device to perform operations comprising:
repeatedly receiving, from a search engine device at which a web site is registered, updates to past search engine performance information of the web site, wherein the past search engine performance information includes search impressions for web pages of the web site;
repeatedly receiving, from one or more traffic tracking service devices, updates to past traffic information for the web pages, wherein the past traffic information includes (i) visits to the web pages, and (ii) rankings of the web pages by search keywords;
receiving, via selectable controls on a graphical user interface of a client device, a selection of two or more of a plurality of metrics related to the past search engine performance information and the past traffic information;
transmitting, to the client device, graph data representing values of the selected two metrics over a pre-defined period of time, wherein reception of the graph data causes the client device to plot, on the graphical user interface, a graph indicating the values of the selected two metrics over the pre-defined period of time, wherein the values as shown in the graph for each of the selected two metrics are normalized to one another;
based on a pre-defined mapping of the web pages to categories and sub-categories, aggregating the past search engine performance information and the past traffic information into the categories and the sub-categories, wherein each of the sub-categories is respectively associated with one of the categories, and wherein each of the web pages is respectively associated with one of the sub-categories;
based on a reporting option, determining a subset of the past search engine performance information and the past traffic information; and
transmitting table data representing values of the subset over the pre-defined period of time, wherein reception of the table data causes the client device to display, on the graphical user interface along with the graph, a table indicating the values of the subset over the pre-defined period of time, and wherein columns and rows of the table are defined by the reporting option, and organize the table data by at least one of the web pages, the categories, or the sub-categories.

19. A computing device comprising:
a processor;
memory; and
program instructions, stored in the memory, that upon execution by the at least one processor cause the computing device to perform operations comprising:
repeatedly receiving, from a search engine device at which a web site is registered, updates to past search engine performance information of the web site, wherein the past search engine performance information includes search impressions for web pages of the web site;
repeatedly receiving, from one or more traffic tracking service devices, updates to past traffic information for the web pages, wherein the past traffic information includes (i) visits to the web pages, and (ii) rankings of the web pages by search keywords;
receiving, via selectable controls on a graphical user interface of a client device, a selection of two or more of a plurality of metrics related to the past search engine performance information and the past traffic information;
transmitting, to the client device, graph data representing values of the selected two metrics over a pre-defined period of time, wherein reception of the graph data causes the client device to plot, on the graphical user interface, a graph indicating the values of the selected two metrics over the pre-defined period of time, wherein the values as shown in the graph for each of the selected two metrics are normalized to one another;
based on a pre-defined mapping of the web pages to categories and sub-categories, aggregating the past search engine performance information and the past traffic information into the categories and the sub-categories, wherein each of the sub-categories is respectively associated with one of the categories, and wherein each of the web pages is respectively associated with one of the sub-categories;
based on a reporting option, determining a subset of the past search engine performance information and the past traffic information; and
transmitting table data representing values of the subset over the pre-defined period of time, wherein reception of the table data causes the client device to display, on the graphical user interface along with the graph, a table indicating the values of the subset over the pre-defined period of time, and wherein columns and rows of the table are defined by the reporting option, and organize the table data by at least one of the web pages, the categories, or the sub-categories.

20. The computing device of claim 19, wherein search keywords are respectively related to the web pages, wherein the selectable controls include a search keyword option, wherein selection of the search keyword option causes the table to include (i) a first column that contains one row for each of at least some of the search keywords, (ii) a second column that contains web pages row-wise associated with the search keywords of the first column, (iii) a third column that contains sub-categories row-wise associated with the web pages of the second column, (iv) a fourth column that contains categories row-wise associated with the sub-categories of the third column, and (v) one or more additional columns of the table that contain portions of the table data row-wise associated with the search keywords of the first column.
